(19) United States
(12) Patent Application Publication
(10) Pub. No.: US 2014/0128040 A1
(43) Pub. Date: May 8, 2014

(54) SYSTEM AND METHOD FOR A REMOTE SERVICES SYSTEM

(71) Applicants: Antonio M. Guglielmo, Atlanta, GA (US); Travis C. Key, Jasper, GA (US)

(72) Inventors: Antonio M. Guglielmo, Atlanta, GA (US); Travis C. Key, Jasper, GA (US)

(21) Appl. No.: 13/651,180

(22) Filed: Oct. 12, 2012

Related U.S. Application Data
(60) Provisional application No. 61/546,334, filed on Oct. 12, 2011.

(51) Int. Cl. H04W 4/16

(52) U.S. Cl. CPC H04W 4/16
USPC 455/414.1

(57) ABSTRACT

An exemplary embodiment includes a system and method for delivering remote servicing on a computer system. The computer system includes a tangible storage medium readable by the instruction processing system and storing instructions for execution by the instruction processing system. The method comprises receiving a phone call from a customer and receiving a digital image of a device being serviced by a service representative. The method further includes displaying the digital image of the device being serviced on a monitor to the service representative, and determining if a service tech needs to make a service visit.

### CROSS-REFERENCE TO RELATED APPLICATIONS

This application claims the benefit of U.S. Provisional Patent Application 61/546,334, filed on Oct. 12, 2011, entitled “SYSTEM AND METHOD FOR A REMOTE SERVICES SYSTEM”, which is incorporated by reference herein in its entirety.

### FIELD OF THE INVENTION

The present invention generally relates to remote servicing; and more particularly to a system and method of delivering remote servicing, wherein the use of photographic images of a device being serviced are electronically transmitted to the location of the service representative which would then be reviewed to determine if a service tech needs to make a service visit.

### DESCRIPTION OF BACKGROUND

One way to provide support and repair of computers, electronic device and the like, of consumers is through on-site services. On-site support services may be delivered via technical labor visiting the location of the malfunctioning device to solve problems. Information about the malfunctioning device may be acquired in the form of emails, online chat and phone, or remotely attaching to the devices and providing direct support. The delivery of labor to the location of the malfunctioning device is immensely inefficient and expensive because of travel time and because the nature of the work is indeterminate. Resolving a problem in the location of the malfunctioning device may require a short visit or a long visit, and may not be known until the technical labor is on-site. As a result, in service providers typically schedule the availability of technicians with slack time to account for the indeterminate nature of the work as well as travel.

The use of slack time to account for the nature of the work is wasteful and increases the amount of additional labor that may needed as demand increases. Not using slack time or using less slack time may decrease the availability of technicians to handle the next customer. This may result in abandoned customers, decreased response time and decrease customer satisfaction. The nature of the on-site work may be broad in technical scope as it may involve many different devices and software. This makes it very difficult if not nearly impossible for a service provider to find someone who is able to address the full spectrum of work on-site. Often times follow-up visits must be scheduled to complete work which could not be resolved by the dispatched technician. This results in longer delays in resolving the issue at home decreasing the customer's satisfaction with the support experience.

On the other hand, purely remote service cannot resolve problems when access to the computer or other devices is constrained due to malfunction, network issues or connections. Further there may be a hardware issue which requires a physical presence to repair or replace in order to fix. Therefore, it is challenging to provide an optimum customer service experience by using either onsite support or remote customer support.

### SUMMARY OF THE INVENTION

Embodiments of the present invention provide a system and method for delivering remote servicing services, wherein the use of digital images of a device being serviced are electronically transmitted to the location of the service representative which would then be reviewed to determine if a service tech needs to make a service visit.

An exemplary embodiment includes a method for delivering remote servicing embodied in a computer program product for execution on an instruction processing system. The computer system comprises a tangible storage medium readable by computer system and storing instructions for execution by the instruction processing system for performing the method. The method comprises receiving a phone call from a customer and receiving a digital image of a device being serviced by a service representative. The method further includes displaying the digital image of the device being serviced on a monitor to the service representative, and determining if a service tech needs to make a service visit.

Another exemplary embodiment includes a system for delivering remote servicing on a computer system. Briefly described in terms of architecture, one embodiment of the system, among others, is implemented as follows: The system includes a tangible storage medium readable by the computer system and storing instructions for execution by the computer system. The system further includes a means for receiving a phone call from a customer, and a means for receiving a digital image of a device being serviced by a service representative. The system further includes a means for displaying the digital image of the device being serviced on a monitor to the service representative, and a means for determining if a service tech needs to make a service visit.

A further exemplary embodiment includes a computer program product for providing vehicle valuation management services on a computer system. The computer program product includes a tangible storage medium readable by a computer system and storing instructions or execution by the computer system for performing a method. The method comprises receiving a phone call from a customer and receiving a digital image of a device being serviced by a service representative. The method further includes displaying the digital image of the device being serviced on a monitor to the service representative, and determining if a service tech needs to make a service visit

These and other aspects, features and advantages of the invention will be understood with reference to the drawing figure and detailed description herein, and will be realized by means of the various elements and combinations particularly pointed out in the appended claims. It is to be understood that both the foregoing general description and the following brief description of the drawing and detailed description of the invention are exemplary and explanatory of preferred embodiments of the invention, and are not restrictive of the invention, as claimed

### BRIEF DESCRIPTION OF THE DRAWINGS

The subject matter which is regarded as the invention is particularly pointed out and distinctly claimed in the claims at the conclusion of the specification. The foregoing and other objects, features, and advantages of the invention are apparent from the following detailed description taken in conjunction with the accompanying drawings in which:

FIG. 1 is a block diagram illustrating an example of the network environment for the remote servicing services of the present invention.

FIG. 2A is a block diagram illustrating an example of a server utilizing the remote servicing services of the present invention, as shown in FIG. 1.

FIG. 2B is a block diagram illustrating an example of a remote device utilizing the remote device system, as shown in FIG. 1.

FIG. 3A is a flow chart illustrating an example of the operation of the remote servicing system for the host of the present invention utilized by the server, as shown in FIG. 2A.

FIG. 3B is a flow chart illustrating an example of the operation of the remote servicing system for the remote device of the present invention, as shown in FIG. 2B.

FIG. 4A is a flow chart illustrating an example of the operation of the remote service call process of the present invention utilized by the server, as shown in FIGS. 2A & 3A.

FIG. 4B is a flow chart illustrating an example of the operation of the remote service call app for the remote device of the present invention, as shown in FIG. 2B.

FIG. 5 is a flow chart illustrating an example of the operation of the locate process that is utilized in the remote servicing system of the present invention, as shown in FIGS. 2A, 3A & 4A.

FIG. 6 is a flow chart illustrating an example of the operation of select service process that is utilized in the remote servicing system of the present invention, as shown in FIGS. 2A, 3A & 4A.

FIG. 7 is a flow chart illustrating an example of the operation of billing process that is utilized in the remote servicing system of the present invention, as shown in FIGS. 2A, 3A & 4A.

FIG. 8 is a flow chart illustrating an example of the operation of sales/service process that is utilized in the remote servicing system of the present invention, as shown in FIGS. 2A, 3A & 4A.

FIG. 9 is a flow chart illustrating an example of the operation of remote interaction process that is utilized in the remote servicing system of the present invention, as shown in FIGS. 2A, 3A & 4A.

FIG. 10A is a flow chart illustrating an example of the operation of the policy process the host of the present invention utilized by the server, as shown in FIGS. 2A & 3A.

FIG. 10B is a flow chart illustrating an example of the operation of the policy app for the remote device of the present invention, as shown in FIG. 2B.

FIG. 11 is a flow chart illustrating an example of the operation of the quote process that is utilized in the remote servicing system of the present invention, as shown in FIGS. 2A, 3A & 10A.

FIG. 12 is a flow chart illustrating an example of the operation of admin process that is utilized in the remote servicing system of the present invention, as shown in FIGS. 2A, 3A & 10A.

FIG. 13 is a flow chart illustrating an example of the operation of asset/claim process that is utilized in the remote servicing system of the present invention, as shown in FIGS. 2A, 3A & 10A.

FIG. 14 is a flow chart illustrating an example of the operation of agent interaction process that is utilized in the remote servicing system of the present invention, as shown in FIGS. 2A, 3A & 10A.

FIG. 15 is a flow chart illustrating an example of the operation of the intelligent routing process that is utilized in the remote servicing system of the present invention, as shown in FIGS. 2A & 8A.

The detailed description explains the preferred embodiments of the invention, together with advantages and features, by way of example with reference to the drawings.

### DETAILED DESCRIPTION OF THE INVENTION

The present invention may be understood more readily by reference to the following detailed description of the invention taken in connection with the accompanying drawing figures, which form a part of this disclosure. It is to be understood that this invention is not limited to the specific devices, methods, conditions or parameters described and/or shown herein, and that the terminology used herein is for the purpose of describing particular embodiments by way of example only and is not intended to be limiting of the claimed invention.

The invention described hereafter is applicable on all remote devices connected to a server hosting the remote servicing system and method of the present invention. While described below with respect to a single computer, the system and method for a webpage build system is typically implemented in a networked computing environment in which a number of computing devices communicate over a local area network (LAN), over a wide area network (WAN), or over a combination of both LAN and WAN.

In one embodiment, a user downloads application from Apple app store, Android Market, Amazon App store, direct email download, or from hosted web site to their mobile device, tablet, or computer. The application is opened by pressing on the touch screen on the device or clicked on with input device. Upon first launch of the application the application check to see what type of device it has been installed on and prompts user for geolocation access if device contains geolocation device such as a GPS receiver. If the GPS receiver is available and finds a valid location it passes on the information via cellular wi-fi or communications network (further referred to as network) to a geolocation server which cross checks the location to available services in the area. If the GPS receiver is unavailable or user opts to not allow this feature, the user is prompted via the device with a visual prompt on to enter the zip code of their service address. The zip code information is sent to a service cloud server via the network hosting a database of zip codes and service providers.

The list of services available in the area is passed on to the user in a list form of selectable icons or words of service providers. The user selects the icon or name of the provider in which they wish to connect and that selection is sent to the service cloud server. If the provider the user selects does not subscribe to the service, the user is prompted with a message requesting the service provider add support via the application. The user is presented with a preselected message requesting their service provider to add support. The user is also then presented with companies that do utilize the application in their area for subscribing to a new service.

The service cloud server returns a response to the application to prompt the user to enter the identification number of the account. If the user is unable to provide the account ID number a look-up service is available to utilize the account owners SSN number and birthday. The users IP address is also an authentication option if the subscriber is connected via WIFI. The service cloud server sends a request to a local server to provide a list array of subscribed or available services. The user chooses from the list and assuming an available, but not subscribed service is chosen they are routed to a sales lobby. The sales screen allows them to add or delete services on their account.

The user selects a service in which they need help with by pressing the word or icon of the service. The server checks to see if the account is current simultaneously while the user is presented the options, if an account is not current the user is routed to a billing screen. The user is able to make a payment to restore services and after the payment has been processed the user receives a message that the services will be restored. An order message is transmitted to the service provider to restore services. The order message could be machine to machine and restore the services automatically or could be a manual process.

If the account is current, the user is connected to a virtual lobby and routed to wait for support personnel to assist them. Messages to the lobby are available that indicate known physical issues in the service territory such as local or global outages. Messages for sales are also available to upgrade services such as adding premium channels.

The user is able to schedule an appointment for in real time collaboration with the sales representative identifying the appropriate equipment to interact with the users equipment including cables, remotes. The sales representative is able to view the equipment and identify and up sell services such as wireless connectivity. The account representative engages the user in a virtual private room and assists them by utilizing the camera on the device to visually support the needs of the user. The user has the ability to control the audio by activating the audio and the video by activating or disabling the video and controlling the light (if available) of the device via on screen controls.

The support representative utilizes a desktop application to connect into the lobby and private room via user name and password on the video sharing server. The support representative communicates to the user via the speaker of the device or a text field of a chat session based on the preference of the user. The video sharing server records the audio and video of the issue and is available for review to the field technician who is dispatched to the site to repair an issue that the user is unable to repair. Users can also initiate a support session for self installation or continuance of a session via a key code. The key code has been created by the sales or service technician and assigned to that order. This session information is initiated over a phone dialog or text chat support session where the subscriber has contacted the service provider for support or sales. The key code is generated for support for a self installation session and is embedded in a qr code or manually entered. Users log in to the application using the key code and are directly connected to a lobby to be met by a support representative.

In an alternative embodiment, the policy holder initiates application via mobile device with camera. User agrees that the content will be recorded. Policy holder enters account number or identification login or key code. Identification number is sent to server and checked for status of policy. The server returns a response asking the user to select whether to use the camera for a new quote or for a claim. The Policy holder then uses the device to provide video that is recorded by the remote server with the assistance of the Insurance Representative prompting for detail. The user is able to enable the flashlight while recording the information.

In another alternative embodiment, a rear view camera and light is utilized both during the interaction for troubleshooting and for policy adjustment. The software on the host is also capable of controlling the light during interaction for troubleshooting and for policy adjustment.

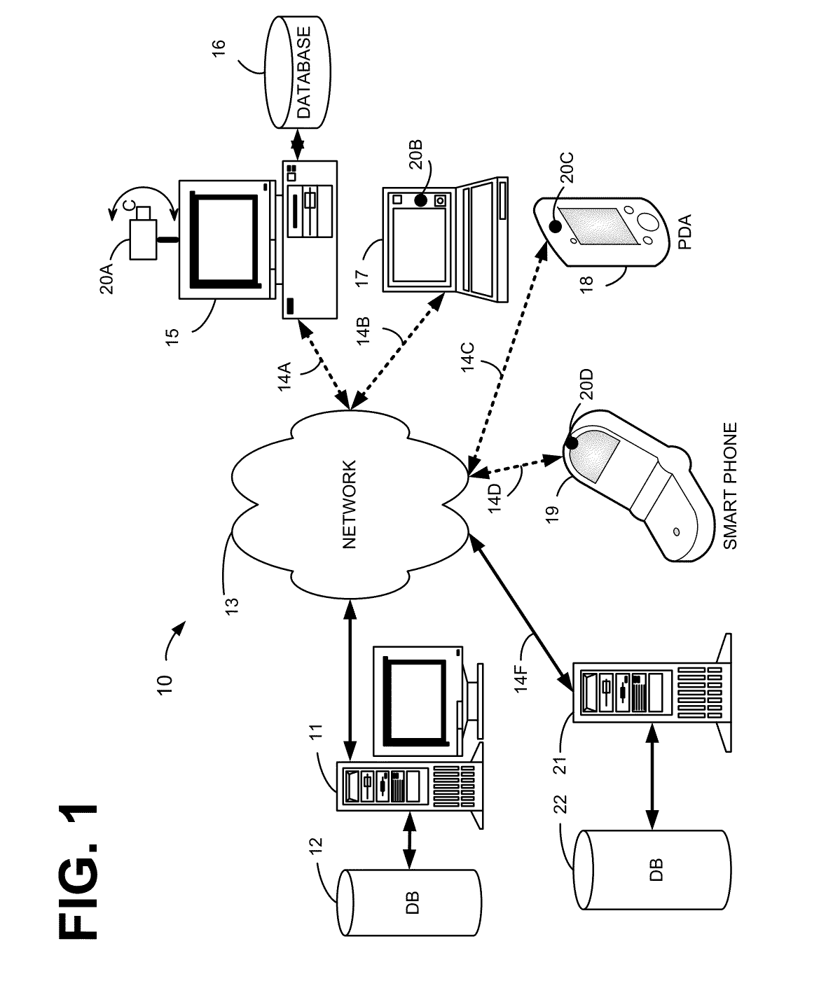

Referring now to the drawings, in which like numerals illustrate like elements throughout the several views. FIG. 1 illustrates an example of the basic components of a system 10 using the remote servicing system used in connection with the preferred embodiment of the present invention. The system 10 includes a server 11 and the remote devices 15, 17-19 or 21 that utilize the remote servicing system of the present invention.

Each remote device 15, 17-19 has applications and can have a local database 16. Server 11 contains applications, and a database 12 that can be accessed by remote device 15, 17-19 via connections 14(A-C), respectively, over network 13. The server 11 runs administrative software for a computer network and controls access to itself and database 12. The remote device 15, 17-19 may access the database 12 over a network 13, such as but not limited to: the Internet, a local area network (LAN), a wide area network (WAN), via a telephone line using a modem (POTS), Bluetooth, WiFi, cellular, optical, satellite, RF, Ethernet, magnetic induction, coax, RS-485, the like or other like networks. The server 11 may also be connected to the local area network (LAN) within an organization (i.e. a university or industrial complex).

The remote device 15, 17-19 may each be located at remote sites. Remote device 15, 17-19 include but are not limited to, PCs, workstations, laptops, handheld computer, pocket PCs, PDAs, pagers, WAP devices, non-WAP devices, cell phones, palm devices, printing devices and the like. Included with each remote device 15, 17-19 is an ability to obtain images of the client. In the remote device 15, there is a special camera for capturing images of devices to be serviced. In remote devices 17 and 18, they are maybe integrated cameras for acquiring images of the devices to be serviced or the ability to download photographs of devices to be serviced in a digital form.

Thus, when a user at one of the remote devices 15, 17-19 desires to access remote servicing services status from the database 12 at the server 11, the remote device 15, 17-19 communicates over the network 13, to access the server 11 and database 12.

Third party vendors computer systems 21 and databases 22 can be accessed by the remote servicing system 100 on server 11 in order to access product offerings and ordered products. Data that is obtained from third party vendors computer system 21 and database 22 can be stored on server 11 and database 12 in order to provide later access to the user on remote devices 15, 17-19. It is also contemplated that for certain types of data that the remote devices 15, 17-19 can access the third party vendors computer systems 21 and database 22 directly using the network 13.

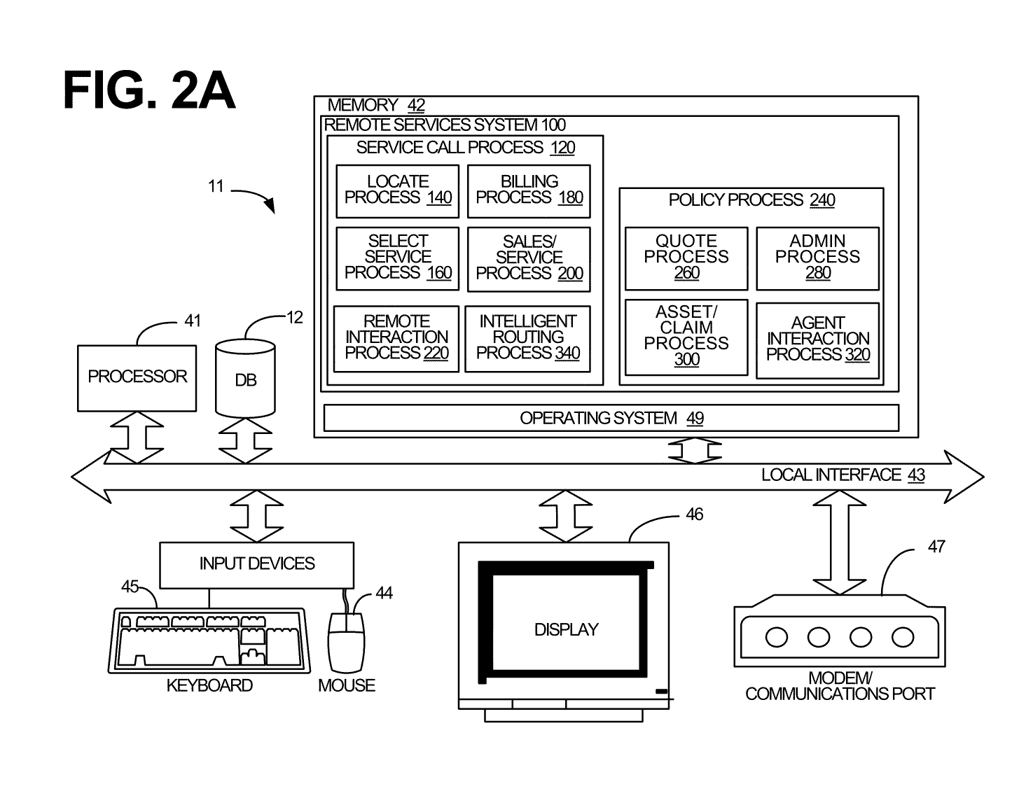

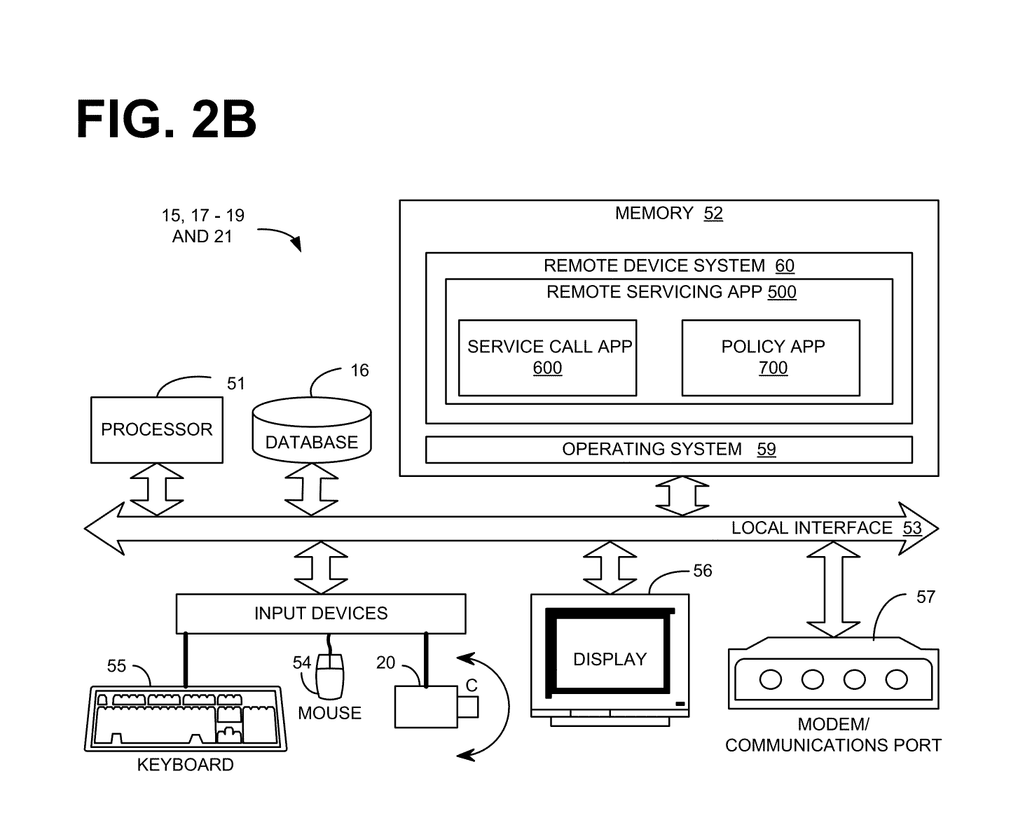

Illustrated in FIG. 2A is a block diagram demonstrating an example of server 11, as shown in FIG. 1, utilizing the remote servicing system 100 of the present invention. Server 11 includes, but is not limited to, PCs, workstations, laptops, PDAs, palm devices and the like. Illustrated in FIG. 2B is an example demonstrating a remote devices 15, 17-19 utilizing the remote servicing app 500 of the present invention. The processing components of the third party vendors computer systems 21 are similar to that of the description for the server 11 (FIG. 2A).

Generally, in terms of hardware architecture, as shown in FIG. 2A, the server 11 include a processor 41, memory 42, and one or more input and/or output (I/O) devices (or peripherals) that are communicatively coupled via a local interface 43. The local interface 43 can be, for example but not limited to, one or more buses or other wired or wireless connections, as is known in the art. The local interface 43 may have additional elements, which are omitted for simplicity, such as controllers, buffers (caches), drivers, repeaters, and receivers, to enable communications. Further, the local interface 43 may include address, control, and/or data connections to enable appropriate communications among the aforementioned components.

The processor 41 is a hardware device for executing software that can be stored in memory 42. The processor 41 can be virtually any custom made or commercially available processor, a central processing unit (CPU), data signal processor (DSP) or an auxiliary processor among several processors associated with the server 11, and a semiconductor based microprocessor (in the form of a microchip) or a macroprocessor. Examples of suitable commercially available microprocessors are as follows: an 80×86 or Pentium series microprocessor from Intel Corporation, U.S.A., a PowerPC microprocessor from IBM, U.S.A., a Sparc microprocessor from Sun Microsystems, Inc, a PA-RISC series microprocessor from Hewlett-Packard Company, U.S.A., or a 68xxx series microprocessor from Motorola Corporation, U.S.A. or an ARMvX microprocessor licensed from ARM Holdings, U.K

The memory 42 can include any one or combination of volatile memory elements (e.g., random access memory (RAM, such as dynamic random access memory (DRAM), static random access memory (SRAM), etc.)) and nonvolatile memory elements (e.g., ROM, erasable programmable read only memory (EPROM), electronically erasable programmable read only memory (EEPROM), programmable read only memory (PROM), tape, compact disc read only memory (CD-ROM), disk, diskette, cartridge, cassette or the like, etc.). Moreover, the memory 42 may incorporate electronic, magnetic, optical, and/or other types of storage media. Note that the memory 42 can have a distributed architecture, where various components are situated remote from one another, but can be accessed by the processor 41.

The software in memory 42 may include one or more separate programs, each of which comprises an ordered listing of executable instructions for implementing logical functions. In the example illustrated in FIG. 2A, the software in the memory 42 includes a suitable operating system (O/S) 49 and the remote servicing system 100 of the present invention. As illustrated, the remote servicing system 100 of the present invention comprises numerous functional components including, but not limited to, the remote service call process 120, and policy process 240. The remote service call process 120 further includes, but is not limited to, the locate process 140, select service process 160, billing process 180, sales/service process 200 and remote interaction process 220. The policy process 240 further includes, but is not limited to a quote process 260, admin process 280, asset/claim process 300 and agent interaction process 320.

A non-exhaustive list of examples of suitable commercially available operating systems 49 is as follows (a) a Windows operating system available from Microsoft Corporation; (b) a Netware operating system available from Novell, Inc.; (c) a Macintosh operating system available from Apple Computer, Inc.; (d) a UNIX operating system, which is available for purchase from many vendors, such as the Hewlett-Packard Company, Sun Microsystems, Inc., and AT&T Corporation; (e) a LINUX operating system, which is freeware that is readily available on the Internet; (f) a run time Vxworks operating system from WindRiver Systems, Inc.; or (g) an appliance-based operating system, such as that implemented in handheld computers or personal data assistants (PDAs) (e.g., Symbian OS available from Symbian, Inc., PalmOS available from Palm Computing, Inc., and Windows CE available from Microsoft Corporation).

The operating system 49 essentially controls the execution of other computer programs, such as the remote servicing system 100, and provides scheduling, input-output control, file and data management, memory management, and communication control and related services. However, it is contemplated by the inventors that the remote servicing system 100 of the present invention is applicable on all other commercially available operating systems.

The remote servicing system 100 may be a source program, executable program (object code), script, or any other entity comprising a set of instructions to be performed. When a source program, then the program is usually translated via a compiler, assembler, interpreter, or the like, which may or may not be included within the memory 42, so as to operate properly in connection with the O/S 49. Furthermore, the remote servicing system 100 can be written as (a) an object oriented programming language, which has classes of data and methods, or (b) a procedure programming language, which has routines, subroutines, and/or functions, for example but not limited to, C, C++, C#, Pascal, BASIC, API calls, HTML, XHTML, XML, ASP scripts, FORTRAN, COBOL, Perl, Java, ADA, .NET, and the like.

The I/O devices may include input devices, for example but not limited to, a mouse 44, keyboard 45, scanner (not shown), microphone (not shown), etc. Furthermore, the I/O devices may also include output devices, for example but not limited to, a printer (not shown), display 46, etc. Finally, the I/O devices may further include devices that communicate both inputs and outputs, for instance but not limited to, a NIC or modulator/demodulator 47 (for accessing remote devices, other files, devices, systems, or a network), a radio frequency (RF) or other transceiver (not shown), a telephonic interface (not shown), a bridge (not shown), a router (not shown), etc.

If the server 11 is a PC, workstation, intelligent device or the like, the software in the memory 42 may further include a basic input output system (BIOS) (omitted for simplicity). The BIOS is a set of essential software routines that initialize and test hardware at startup, start the O/S 49, and support the transfer of data among the hardware devices. The BIOS is stored in some type of read-only-memory, such as ROM, PROM, EPROM, EEPROM or the like, so that the BIOS can be executed when the server 11 is activated.

When the server 11 is in operation, the processor 41 is configured to execute software stored within the memory 42, to communicate data to and from the memory 42, and generally to control operations of the server 11 are pursuant to the software. The remote servicing system 100 and the O/S 49 are read, in whole or in part, by the processor 41, perhaps buffered within the processor 41, and then executed.

When the remote servicing system 100 is implemented in software, as is shown in FIG. 2A, it should be noted that the remote servicing system 100 can be embodied in any computer-readable medium for use by or in connection with an instruction execution system, apparatus, or device, such as a computer-based system, processor-containing system, or other system that can fetch the instructions from the instruction execution system, apparatus, or device and execute the instructions.

In the context of this document, a “computer-readable medium” can be any means that can store, communicate, propagate, or transport the program for use by or in connection with the instruction execution system, apparatus, or device. The computer readable medium can be, for example but not limited to, an electronic, magnetic, optical, electromagnetic, infrared, or semiconductor system, apparatus, device, propagation medium, or other physical device or means that can contain or store a computer program for use by or in connection with a computer related system or method.

More specific examples (a nonexhaustive list) of the computer-readable medium would include the following: an electrical connection (electronic) having one or more wires, a portable computer diskette (magnetic or optical), a random access memory (RAM) (electronic), a read-only memory (ROM) (electronic), an erasable programmable read-only memory (EPROM, EEPROM, or Flash memory) (electronic), an optical fiber (optical), and a portable compact disc memory (CDROM, CD R/W) (optical). Note that the computer-readable medium could even be paper or another suitable medium, upon which the program is printed or punched (as in paper tape, punched cards, etc.), as the program can be electronically captured, via for instance optical scanning of the paper or other medium, then compiled, interpreted or otherwise processed in a suitable manner if necessary, and then stored in a computer memory.

In an alternative embodiment, where the remote servicing system 100 is implemented in hardware, the remote servicing system 100 can be implemented with any one or a combination of the following technologies, which are each well known in the art: a discrete logic circuit(s) having logic gates for implementing logic functions upon data signals, an application specific integrated circuit (ASIC) having appropriate combinational logic gates, a programmable gate array(s) (PGA), a field programmable gate array (FPGA), etc.

Illustrated in FIG. 2B is a block diagram demonstrating an example of functional elements in the remote device 15, 17-19, that enables access to the remote servicing app 500 of the present invention, as shown in FIG. 2A. The remote devices 15, 17-19 provides access to the remote servicing system 100 of the present invention on server 11 and database 12 using the remote servicing app 500, including for example, but not limited to an Internet browser. The information accessed in server 11 and database 12 can be provided in the number of different forms including but not limited to ASCII data, WEB page data (i.e. HTML), XML or other type of formatted data.

Included with each remote device 15, 17-19 is an ability to obtain images of the client. In the remote device 15, there is a camera 58 for capturing images of client 20. In remote devices 17 and 18, they are maybe integrated cameras 58 for acquiring images of the client or the ability to download photographs of client 20 in a digital form.

As illustrated, the remote device 15, 17-19 and 21 are similar to the description of the components for server 11 described with regard to FIG. 2A. Hereinafter, the remote devices 15, 17-19 that will be referred to as remote devices 15 for the sake of brevity.

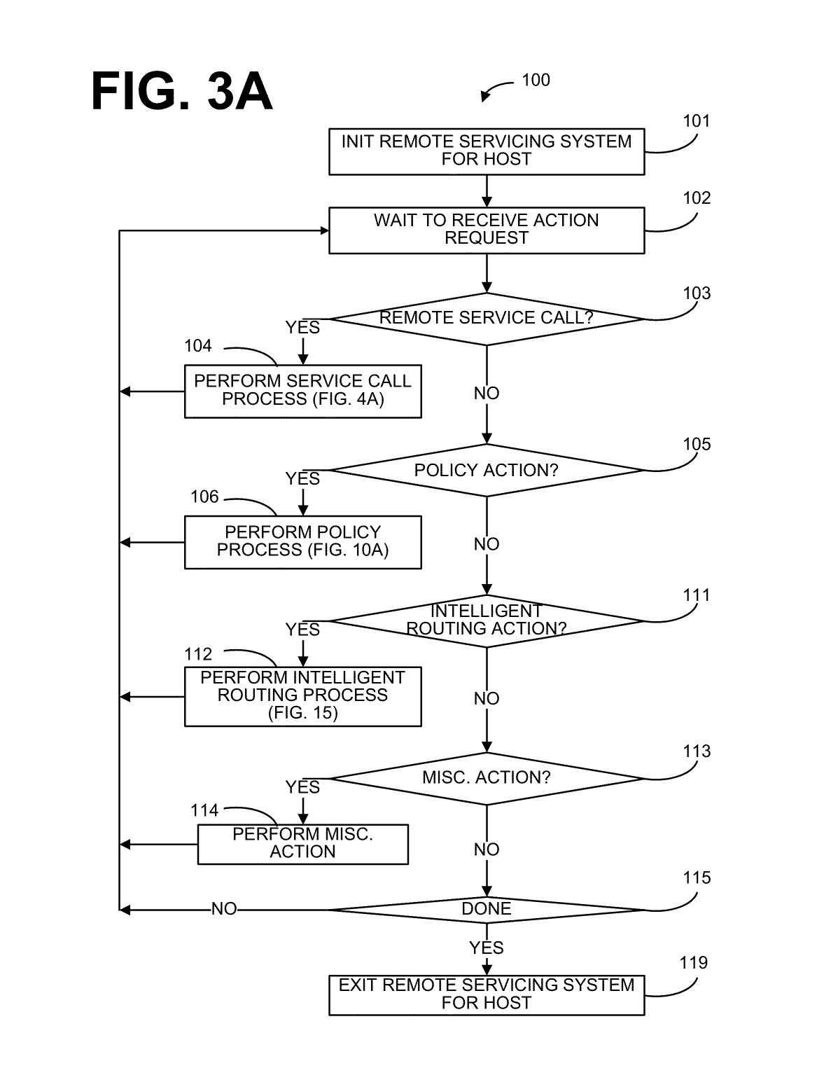

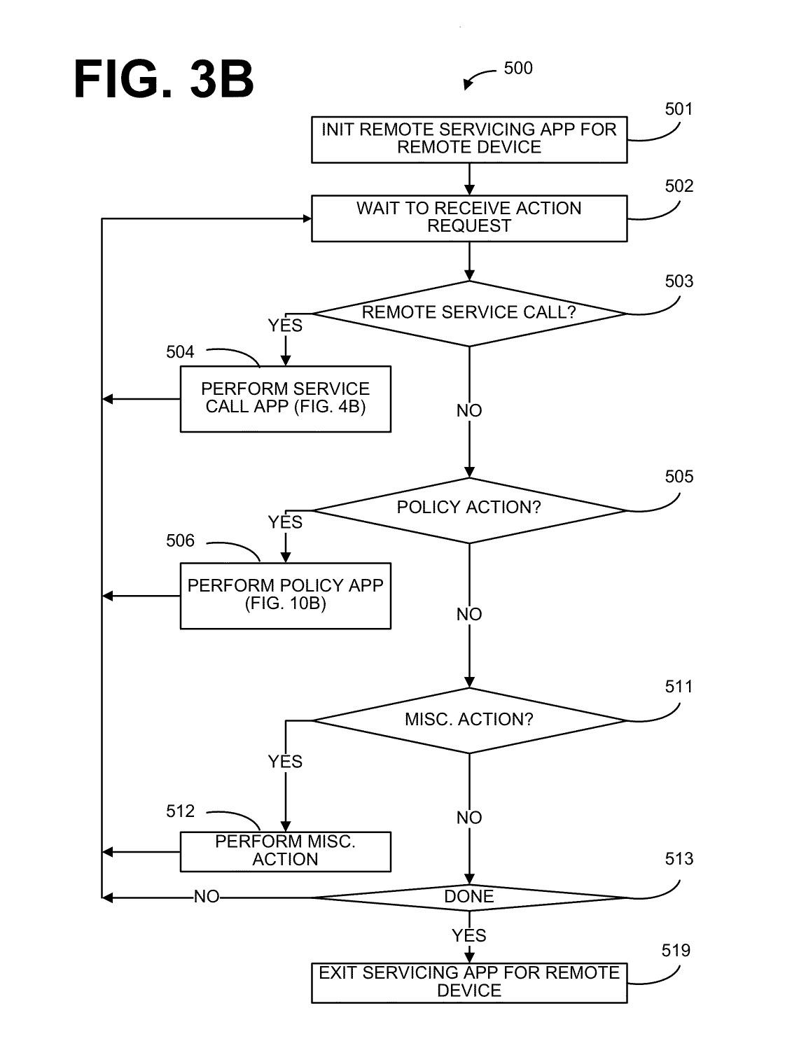

FIG. 3A is a flow chart illustrating an example of the operation of the remote servicing system 100 of the present invention utilized by the server 11, as shown in FIGS. 1 and 2A. The remote servicing system 100 shows the combined embodiments of the service call process and the policy process. It is understood that normally only the service call process or the policy process would be active in the remote servicing system 100. However, for illustration purposes, the remote servicing system 100 shows both of the embodiments of the service call process and policy process together.

The remote servicing system 100 of the present invention provides a support representative the ability to utilize a desktop application to connect into the lobby and private room via user name and password on the video sharing server. The support representative communicates to the user via the speaker of the device or a text field of a chat session based on the preference of the user. The video sharing server records the audio and video of the issue and is available for review to the field technician who is dispatched to the site to repair an issue that the user is unable to repair.

First at step 101, the remote servicing system 100 is initialized. This initialization includes the startup routines and processes embedded in the BIOS of the server 11. The initialization also includes the establishment of data values for particular data structures utilized in the remote servicing system 100.

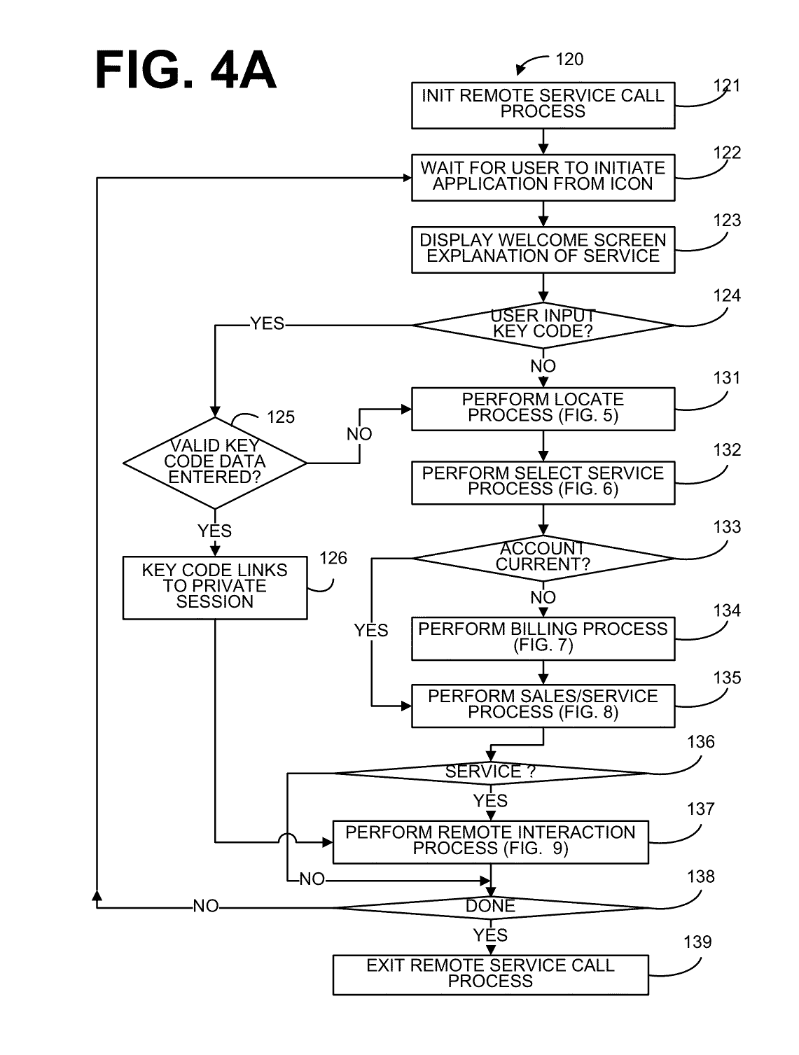

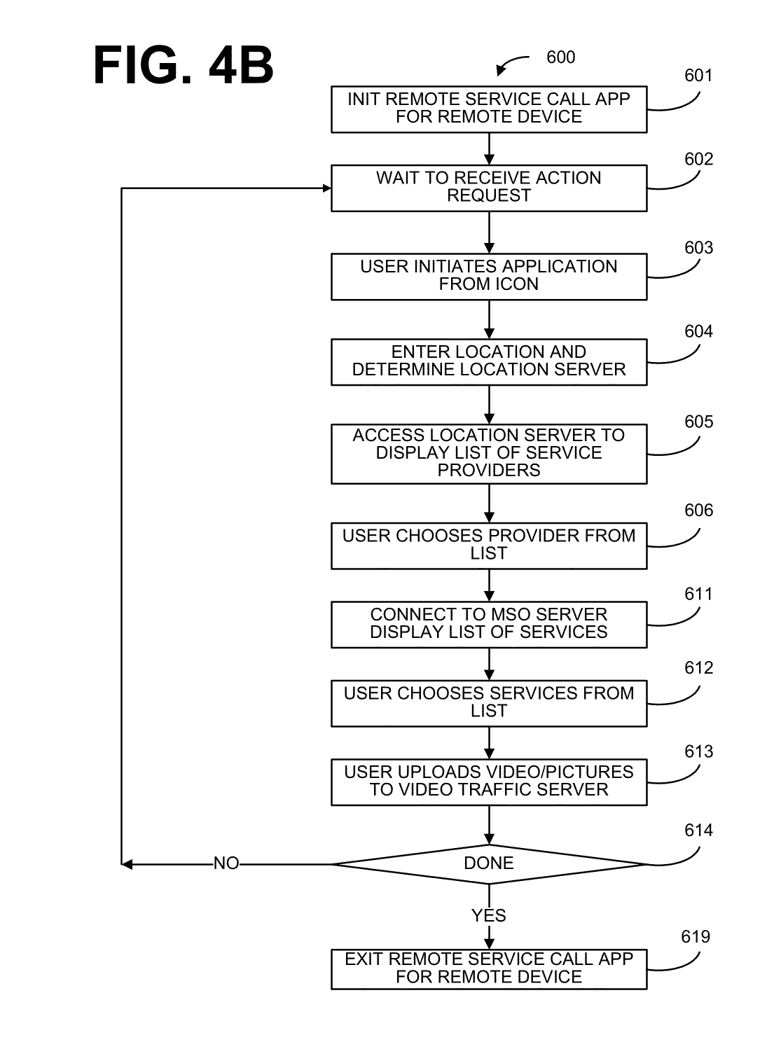

At step 102, the remote servicing system 100 waits to receive an action request. After receiving an action request at step 102, the remote service system 100 determines if the action to be performed is a remote service call at step 103. If it is determined in step one of three that the action to be performed is a remote service call, then the remote servicing system 100 performs the service call process at step 104. This service call process is here and find it further detail with regard FIG. 4A. After performing the service call process, the remote servicing system 100 returns to wait to receive an action request at step 102.

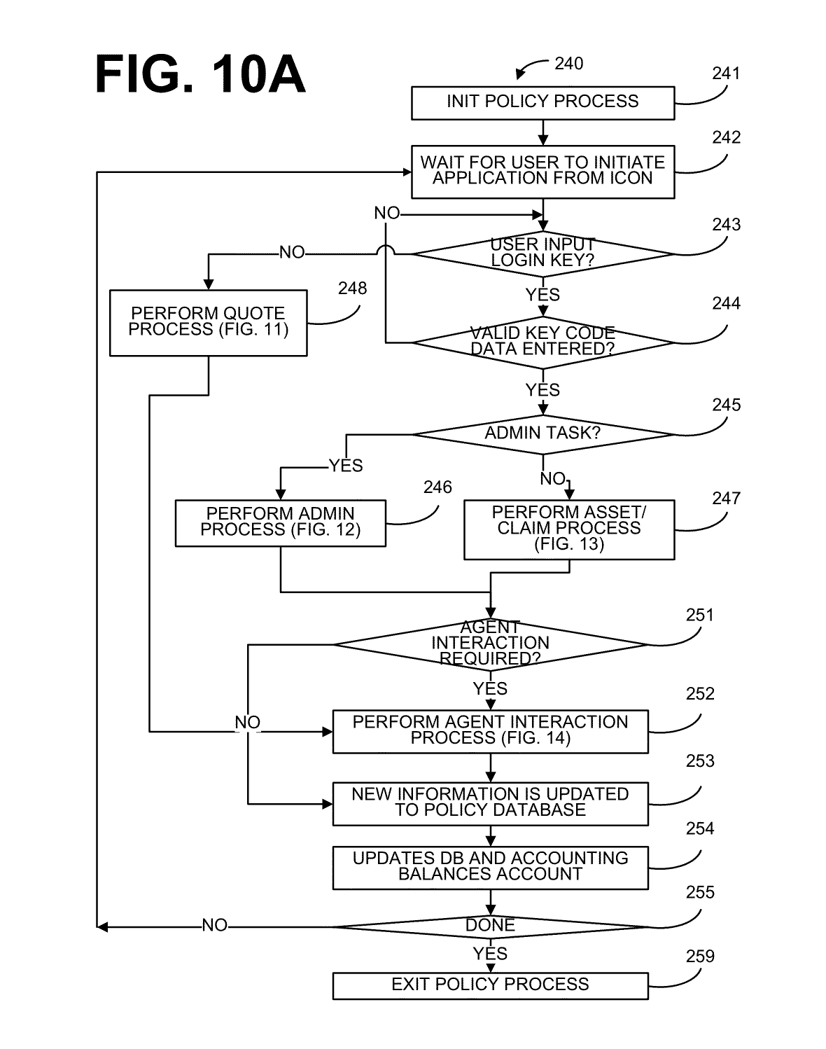

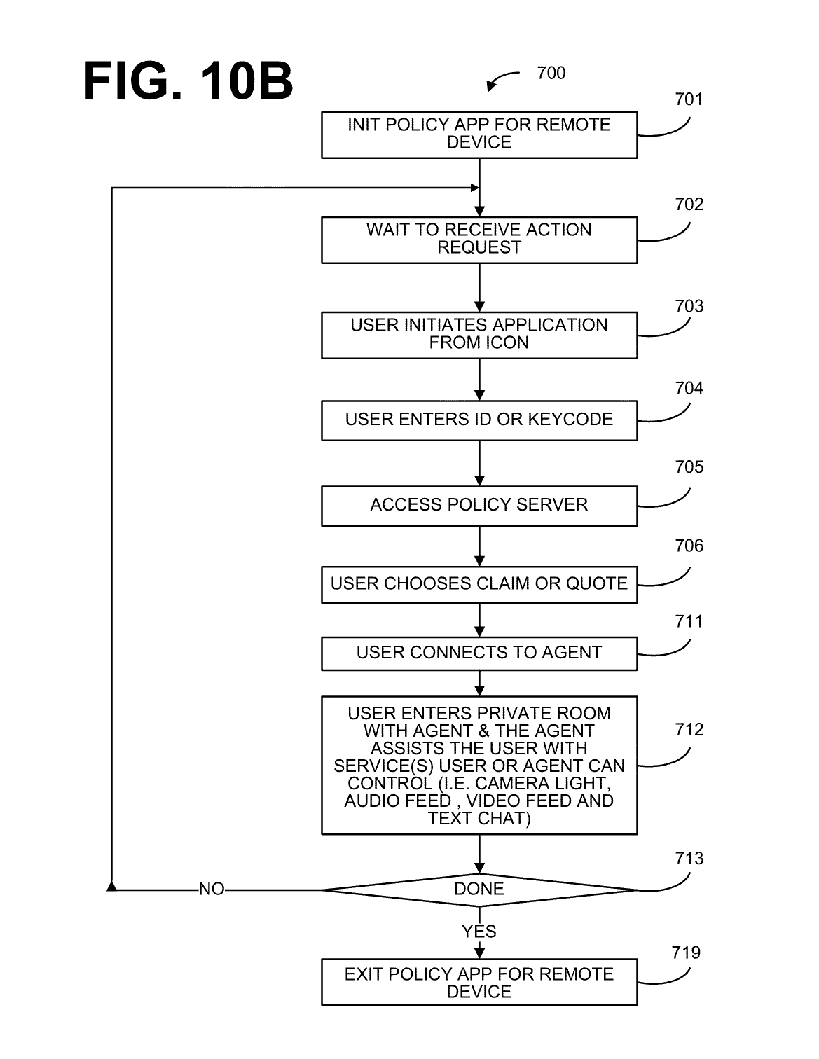

However, if it is determined at step 103 that the action request is not a remote service call, then the remote servicing system 100 determines if the action request is a policy action at step 105. If it is determined at step 105 that the action request is a policy action, then the remote servicing system 100 performs the policy process at step 106. The policy process herein defined in further detail with regard FIG. 10A. After performing the policy process, the remote servicing system 100 returns to wait to receive an action request at step 102.

However, if it is determined at step 105 that the action request is not a policy action, then the remote servicing system 100 determines if the action request is a intelligent routing action at step 111. If it is determined at step 111 that the action request is a intelligent routing action, then the remote servicing system 100 performs the intelligent routing process at step 112. After performing the intelligent routing process, the remote servicing system 100 returns to wait to receive an action request at step 102.

However, if it is determined at step 111 that the action request is not a intelligent routing, then the remote servicing system 100 determines if the action request is a miscellaneous action at step 113. If it is determined at step 113 that the action request is a miscellaneous action, then the remote servicing system 100 performs the miscellaneous process at step 114. After performing the miscellaneous process, the remote servicing system 100 returns to wait to receive an action request at step 102.

However, if it is determined at step 113 that the action request is not a miscellaneous action, then the remote servicing system 100 determines if the action request is an exit action at step 115. If it is determined at step 115 that the action request is an exit action, then the remote servicing system 100 exits at step 119.

FIG. 3B is a flow chart illustrating an example of the operation of the remote servicing app 500 of the present invention utilized by the remote device 15, as shown in FIGS. 1 and 2B. The remote servicing app 500 shows the combined embodiments of the service call app and the policy app. It is understood that normally only the service call app or the policy app would be active in the remote servicing app 500. However, for illustration purposes, the remote servicing system 100 shows both of the embodiments of the service call app and policy app together.

The remote servicing app 500 of the present invention provides a user the ability to utilize a remote device 15 to connect into the lobby and private room via user name and password on the video sharing server. The user support representative communicates to the support representative via the speaker of the remote device 15 or a text field of a chat session on the remote device 15, based on the preference of the user. The video sharing server records the audio and video of the issue and is available for review to the field technician who is dispatched to the site to repair an issue that the user is unable to repair.

First at step 501, the remote servicing app 500 is initialized. This initialization includes the startup routines and apps embedded in the BIOS of the server 11. The initialization also includes the establishment of data values for particular data structures utilized in the remote servicing app 500.

At step 502, the remote servicing app 500 waits to receive a action request. After receiving an action request at step 502, the remote servicing app 500 determines if the action to be performed is a remote service call at step 503. If it is determined in step one of three that the action to be performed is a remote service call, then the remote servicing app 500 performs the service call app at step 504. This service call app is here and find it further detail with regard FIG. 4B. After performing the service call app, the remote servicing app 500 returns to wait to receive a user's input of an action request at step 502.

However, if it is determined at step 503 that the action request is not a remote service call, then the remote servicing app 500 determines if the action request is a policy action at step 505. If it is determined at step 505 that the action request is a policy action, then the remote servicing app 500 performs the policy app at step 506. The policy app herein defined in further detail with regard FIG. 10B. After performing the policy app, the remote servicing app 500 returns to wait to receive an action request at step 502.

However, if it is determined at step 505 that the action request is not a policy action, then the remote servicing app 500 determines if the action request is a miscellaneous action at step 511. If it is determined at step 511 that the action request is a miscellaneous action, then the remote servicing app 500 performs the miscellaneous app at step 512. After performing the miscellaneous app, the remote servicing app 500 returns to wait to receive an action request at step 502.

However, if it is determined at step 511 that the action request is not a miscellaneous action, then the remote servicing app 500 determines if the action request is an exit action at step 513. If it is determined at step 513 that the action request is an exit action, then the remote servicing app 500 experts at step 519.

FIG. 4A is a flow chart illustrating an example of the operation of the remote service call process 120 of the present invention utilized by the server 11, as shown in FIGS. 2A & 3A. First, the remote service call process 120 waits for a user to initiate the application. Next, a welcome screen explaining the services provided is displayed. The remote service call process 120 then checks to see if the user input a key code. If the key code is input, then it is validated. If the key code is valid, then the customer is linked to a private session and the remote service call process 120 then skips to perform the remote interaction process below. However, if the key code is not input or is invalid, then the locate process is performed to determine the location of the service call. Next, the user selects the remote service to be performed from a list of service providers. At this time, the remote service call process checks to make sure that the users account is current. If the user's account is current, then the remote service call process 120 skips to perform the sales/service process. However, it is determined that the account is not current, and the remote service call process 120 performs the billing process in order to place the user's account into a current status. Next, the sales/service process is then performed. Next it is determined that the user has selected a service to be performed. If not, then the remote service call process 120 skips to see if there's more interaction with this user. However, it is determined that the user has selected a service to be performed, then the remote service call process 120 performs a remote interaction process. Last it is determined if there's more interaction with this user. If it is determined that there is more interaction with this user, then the remote service call process 120 returns to step one to wait for the user to initiate the application. However, if there is no more interaction with the user, the remote service call process then exits.

First at step 121, the remote service call process 120 is initialized. This initialization includes the startup routines and processes embedded in the BIOS of the server 11. The initialization also includes the establishment of data values for particular data structures utilized in the remote service call process 120.

At step 122, the remote service call process 120 waits to receive an action request. After receiving an action request at step 122, the remote service call process 120 displays a welcome screen explaining the services provided, at step 123. The remote service call process 120 then checks to see if the user input a key code at step 124. If the key code is input, then it is validated, at step 125. If the key code is valid, then the customer is linked to a private session at step 126, and the remote service call process 120 then skips to step 137 to perform the remote interaction process.

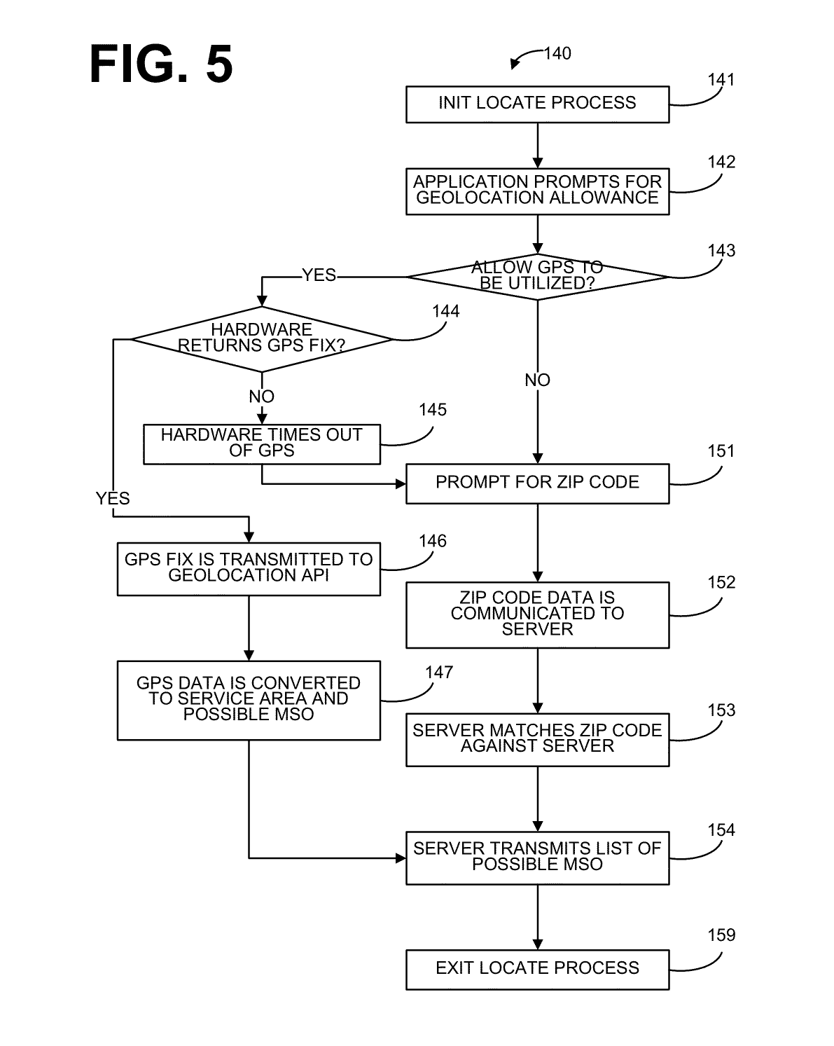

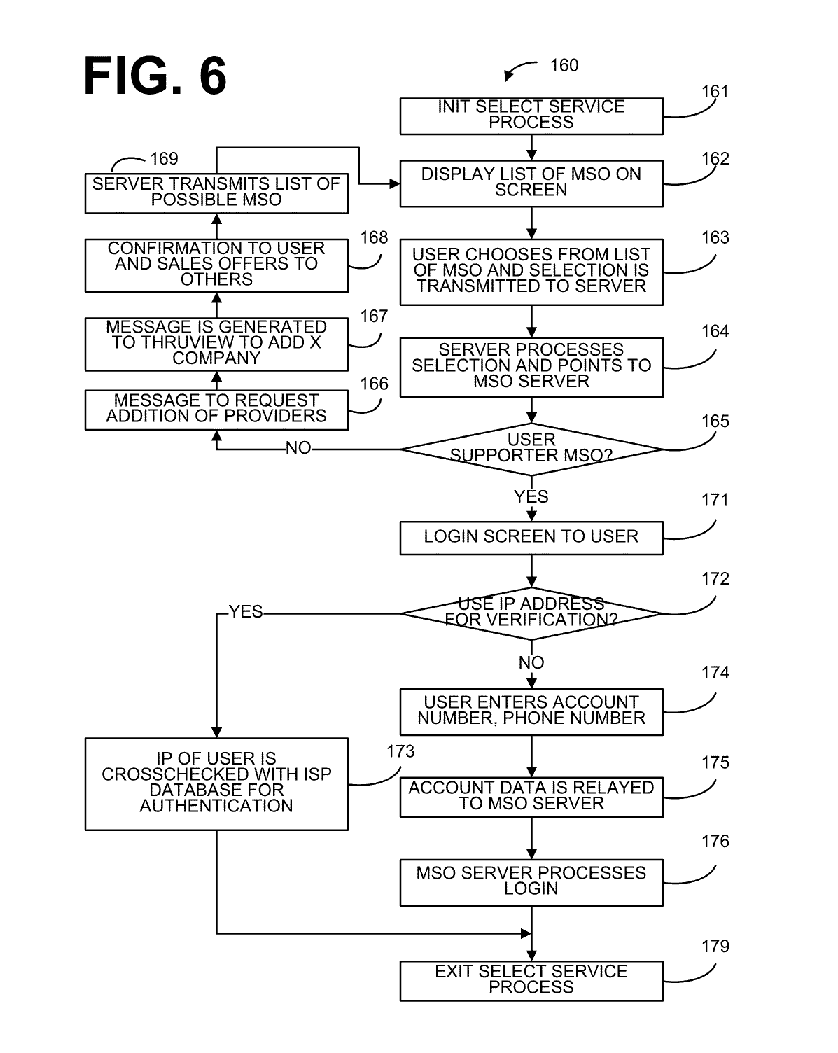

However, if it is determined at step 124 that the key code is not input or it is determined at step 125 that the key code is invalid, then the remote service call process 120 performs the locate process at step 131. The locate process determines the location of the service call and is herein defined in further detail with regard FIG. 5. Next, the remote service call process 120 performs select service process at step 132. The select service process enables the user to select the remote service to be performed from a list of service providers. The select service process is herein defined in further detail with regard FIG. 6.

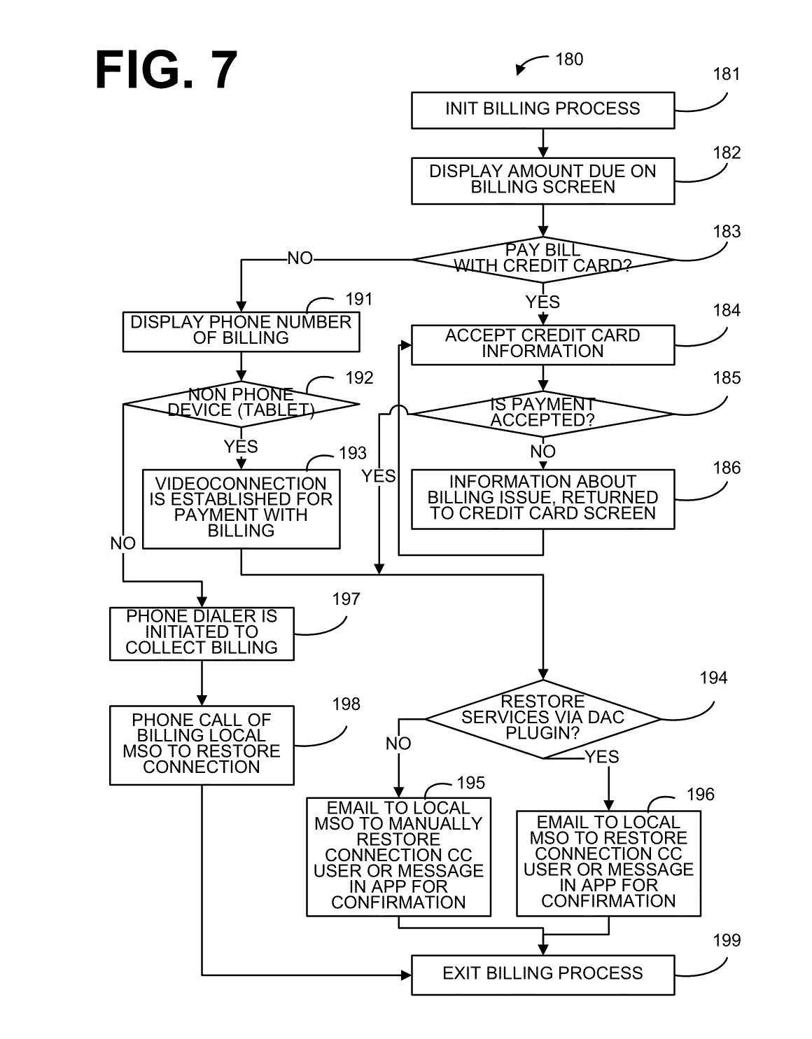

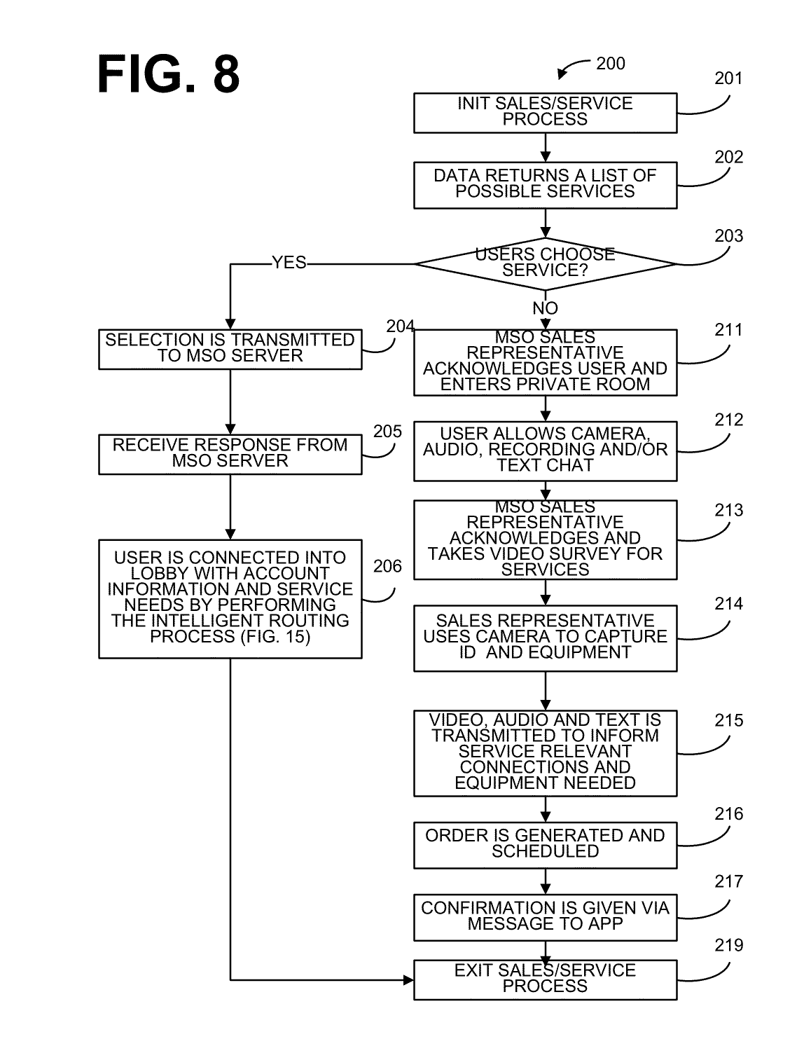

At step 133, the remote service call process 120 checks to make sure that the users account is current. If the user's account is current, then the remote service call process 120 skips to step 135 to perform the sales/service process. However, if it is determined that the account is not current, then the remote service call process 120 performs the billing process in order to place the user's account into a current status at step 134. The billing process enables the user to make their account. The billing process is herein defined for the detail with regard to FIG. 7. Next, the remote service call process 120 performs the sales/service process, at step 135. The sales/service process enables the user to purchase a service or implement a service. The sales/service process herein defined in further detail with regard to FIG. 8.

Next the remote service call process 120 determines if the user has selected a service to be performed at step 136. If the remote service call process 120 determines that a user has not selected a service to be performed at step 135, then the remote service call process 120 skips to step 138 to see if there's more interaction with this user. However, if it is determined that the user has selected a service to be performed at step 135, then the remote service call process 120 performs a remote interaction process at step 137. The remote interaction process enables the user to have remote interaction with a trained representative to assist the user with a service.

At step 138, it is determined if there's more interaction with this user. If it is determined that there is more interaction with this user, then the remote service call process 120 returns to step 122 to wait for the user to initiate the application. However, if it is determined that there is no more interaction with the user, the remote service call process 120 then exits at step 139.

FIG. 4B is a flow chart illustrating an example of the operation of the remote service call app 600 for the remote device 15 of the present invention, as shown in FIG. 2B. the remote service call app 600 prompts a user to indicate the location of the service call, enables a user to display a list of service providers in and around that location and enables the user to select a service from the selective service provider.

First at step 601, the remote service call app 600 is initialized. This initialization includes the startup routines and processes embedded in the BIOS of the remote device 15. The initialization also includes the establishment of data values for particular data structures utilized in the remote service call app 600.

The remote service call app 600 then waits to receive an action request at step 602. Next, a welcome screen explaining the services provided is displayed in the user is prompted to initiate an application from the icon displayed a welcome screen. To initiate some applications, the user must enter a valid key code when initiating the application from an icon at step 603. The remote service call app 600 then prompts the user to input a key code if required. At step 604, the remote service call app 600 prompts the user to enter a location for the service call in order to determine a location of the server 11 to provide services. Next come the remote service call app 600 accesses the location server 11 to display a list of the service providers to provide by the requested service call, at step 605.

At step 606, the user is prompted to choose a provider from the list displayed at step 605. After the user selects the provider to perform the service call at step 606, the remote service call app 600 connects to the MSO (i.e. Multiple Service Operator) server 11 to display a list of services provided by that service provider. MSO's include but are not limited to, cable or telecommunications service providers. Next, the user selects a service to be performed, at step 612. At step 613, and user uploads the video/pictures to the video traffic server 11. This is how the user is able to disclose the actual state of apparatus/device needing service.

Last, it is determined if there is more interaction with this user. If it is determined that there is more interaction with this user, then the remote service call app 600 returns to step 602 to wait for the user to initiate the action request. However, if there is no more interaction with the user, the remote service call app 600 then exits.

FIG. 5 is a flow chart illustrating an example of the operation of the locate process 140 that is utilized in the remote servicing system 100 of the present invention, as shown in FIGS. 2A, 3A & 4A. locate process 140 utilizes a variety of different techniques to determine the location of where the service is to be provided. The different techniques to find the location of where the service is to be provided includes, but is not limited to GPS, zip code, cellular triangulation, input from the user and the like.

First at step 141, the locate process 140 is initialized. This initialization includes the startup routines and processes embedded in the BIOS of the server 11. The initialization also includes the establishment of data values for particular data structures utilized in the locate process 140.

At step 142, the locate process 140 receive an action request for geolocation allowance. Geolocation allowance enables the remote servicing system 100 to find the boundaries or distances from the location where the service to be provided and the service providers After receiving an action request at step 122, the remote service call process 120 displays a welcome screen explaining the services provided, at step 123.

At step 143, the locate process 140 determines if GPS is to be utilized for location determination. It is determined at step 143 that GPS is not to be utilized, then the locate process 140 then skips the step 151. However, if it is determined at step 143 that GPS is to be utilized to determine a location of where the services to be provided, then the locate process 140 then determines if the hardware to be service is returning a GPS fix at step 144. If it is determined at step 144 that the hardware did return a GPS location, then the locate process 140 then skips to step 146. However, it is determined at step 144 that the hardware did not return a GPS fix, then the hardware times out of GPS at step 145 and proceeds to step 151.

At step 146, the locate process 140 uses the GPS fix transmitted to a geolocation API (i.e. application programming interface). At step 147, the GPS data is converted into a service area to determine a possible MSO. The locate process 140 then skips since 154.

At step 151, the locate process prompts the user for MS though ZIP code. After receiving the ZIP code data from the user, the ZIP code data is communicated to the server 11 at step 152. The server 11 matches the ZIP code received from the user against the server master list of possible MSOs that provide service at step 153.

At step 154, the server 11 transmits the list of possible MSOs to the user to enable the user to select the MSO of choice.

The locate process 140 then exits at step 159.

FIG. 6 is a flow chart illustrating an example of the operation of select service process 160 that is utilized in the remote servicing system 100 of the present invention, as shown in FIGS. 2A, 3A & 4A. The select service process a 160 enables a user to select an MSO to provide a particular service.

First at step 161, the select service process 160 is initialized. This initialization includes the startup routines and processes embedded in the BIOS of the server 11. The initialization also includes the establishment of data values for particular data structures utilized in the select service process 160.

At step 162, the select service process 160 displays a list of MSOs to a user on the display screen. At step 163, these select service process 160 enables a user to choose from a list of MSOs and the selection is transmitted to server 11. Server 11 processes the selection and points to the MSO server to provide the service at step 164. At step 165, it is determined if the user is a supporter of the MSO selected. If it is determined at step 165 that the user is a supporter of the MSO selected, then the select service process 160 events gets to step 171. However, it is determined in step 165 that the MSO selected by the user is not a supported MSO, then these select service process 160 sends a message to request the addition of the provider selected at step 166. At step 167, a message is generated and sent to operator of the remote service system 100 (i.e. Thruview LLC) to add the MSO selected at step 163. At step 168, the select service process 160 confirms to the user and sales offers to others of the newly added MSO. At step 169, server 11 transmits the list of possible MSOs to the user and returns to display the list of MSOs at step 162.

At step 171, a login screen is provided to the user. At step 172, it is determined if the Internet protocol (i.e. IP) address of the user is a valid IP address. If it is determined in step 172 that the IP address is not valid for the user, then a select service process 160 skips to step 174. However, if it is determined at step 172 that the IP address for the user is verified, then the IP address of the user is cross checked with the Internet service provider (ISP) for authentication. The select service process 160 then skips to step 179.

At step 174, if it is determined at step 172 that the user IP address was not valid, then the user is prompted to enter the account number and phone number of the user's account. At step 175, the account data is relayed to the MSO server. The MSO server then processes the login information at step 176.

The select service process 160 then exits at step 179.

FIG. 7 is a flow chart illustrating an example of the operation of billing process 180 that is utilized in the remote servicing system 100 of the present invention, as shown in FIGS. 2A, 3A & 4A. the billing process 180 enables a user to display a bill amount due on a display screen, and pay a utilizing a variety of different payment methods. The payment methods include but are not limited to credit card payments, billing to telephone numbers, enabling payment over the phone and the like.

First at step 181, the billing process 180 is initialized. This initialization includes the startup routines and processes embedded in the BIOS of the server 11. The initialization also includes the establishment of data values for particular data structures utilized in the billing process 180.

At step 182, the billing process 180 displays an amount due on the display screen. At step 183, it is determined if the user wishes to pay the bill with a credit card. If it is determined at step 183 that the user does not wish to pay by credit card, then the billing process 180 skips to step 191. However, it is determined in step 183 that the user does wish to pay the bill by credit card, then the credit card and information is accepted in step 184. In step 185, it is determined if the payment amount is accepted. If it is determined in step 185 that the payment was accepted, then the billing process 180 events gets to step 194. However, it is determined in step 185 that the payment was not accepted, and information about the billing issue is returned to be displayed to the user on a display screen at step 186. The billing process 180 then returns to step 184 to except new or modified credit card information.

At step 191, the phone number of the location being billed is display. At step 192 it is determined if the communication device is a non-phone device (i.e. a tablet, laptop, desktop PC, or the like). If it is determined at step 192 that the communication device being utilized by the user is not a non-phone device, then the billing process 180 skips to step 197. However, if it is determined that the communication device utilized by the user is a non-phone device, and a video connection is established for payment with billing at step 193.

At step 194, the billing process 180 then determines if the restoration of services is to be established using a DAC plug-in. (i.e. Digital Addressable Controller) DACs are commonly made by Motorola and include a Motorola Cable Software program and server system which control set top boxes. Another type of DAC is a DNCS-Digital Network Control System made by Scientific Atlanta.

If it is determined at step 194 that the restoration of services is to be accomplished using a DAC plug-in, then the billing process 180 skips to step 196. However, if it is determined at step 195 that the restoration of services is not to be accomplished using a DAC plug-in, then the billing process 180 sends an e-mail to the local MSO to manually restore the connection to the credit card user war sends a message in application for confirmation that payment was made. The billing process 180 then would skip to step 199.

At step 196, if the restoration of services via a back plug-in is to be performed, and the billing process 180 sends an e-mail to the local MSO to restore the connection of the credit card user or message in application for confirmation that payment has been received. The billing process 180 then would skip to step 199.

At step 197, the phone dialer is initiated to collect the billing. In one embodiment, the phone dialer information is established for the user at time of service activation. In another embodiment, the phone dialer information is determined by location of the user and does service to be provided. At step 198, a phone call of billing information is made to the local MSO to restore the connection.

The billing process 180 then exits at step 199.

FIG. 8 is a flow chart illustrating an example of the operation of sales/service process 200 that is utilized in the remote servicing system 100 of the present invention, as shown in FIGS. 2A, 3A & 4A. The sales/service process 200 enables the user to purchase a remote service or to initiate a remote service.

First at step 201, the sales/service process 200 is initialized. This initialization includes the startup routines and processes embedded in the BIOS of the server 11. The initialization also includes the establishment of data values for particular data structures utilized in the sales/service process 200.

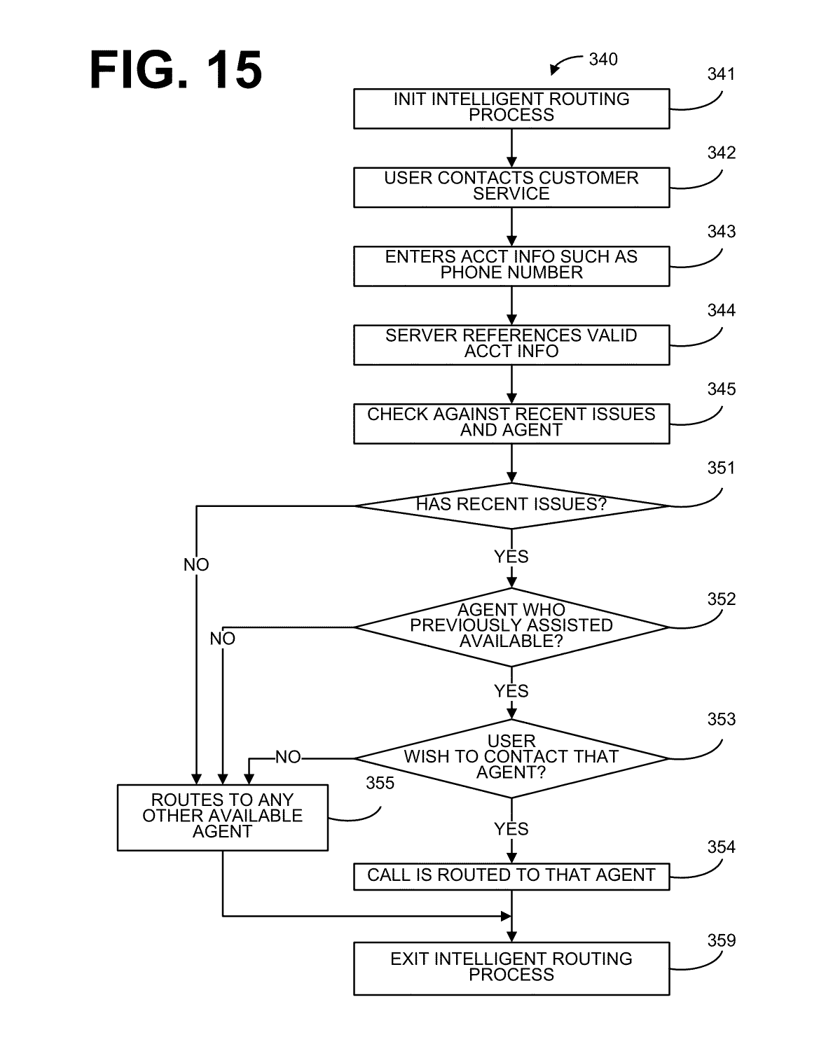

At step 202, the sales/service process 200 returns a list to be displayed of possible services to be provided to a user. At step 203, it is determined if the user chooses to initiate a service. If it is determined at step two and three that the user is not choosing to initiate a service, then the sales/service process 200 skips to step 211. However, if it is determined at step two of three that the user did select to initiate a service, then that's service selected for initiation is transmitted to the MSO server at step 204. At step two of five, the user receives a response from the MSO server. At step two is six, the user is connected into the lobby with detailed information and service needs to be performed by the intelligent routing process. The intelligent routing process is herein defined in further detail with regard to FIG. 15. The sales/service process 200 then skips the step 219.

At step 211, the MSO sales representative acknowledges the user and enters the private chat room. At step to 12, the user allows camera, audio, recording and/or a text chat to be initiated. The MSO sales representative acknowledges the initiation of the camera, audio, recording and or text chat at step 213. The MSO sales representative then takes the video survey for the services to be performed. The sales representative then uses the camera to capture the ID and equipment to be serviced at step 214.

At step 215, the video, audio and text is transmitted to the appropriate service department to inform this service department of relevant connections and the equipment that will be needed for performing remote service. An order is generated and scheduled at step 216. Confirmation is given via message to the user on the remote service call app 600.

The sales/service process 200 then exits at step 219.

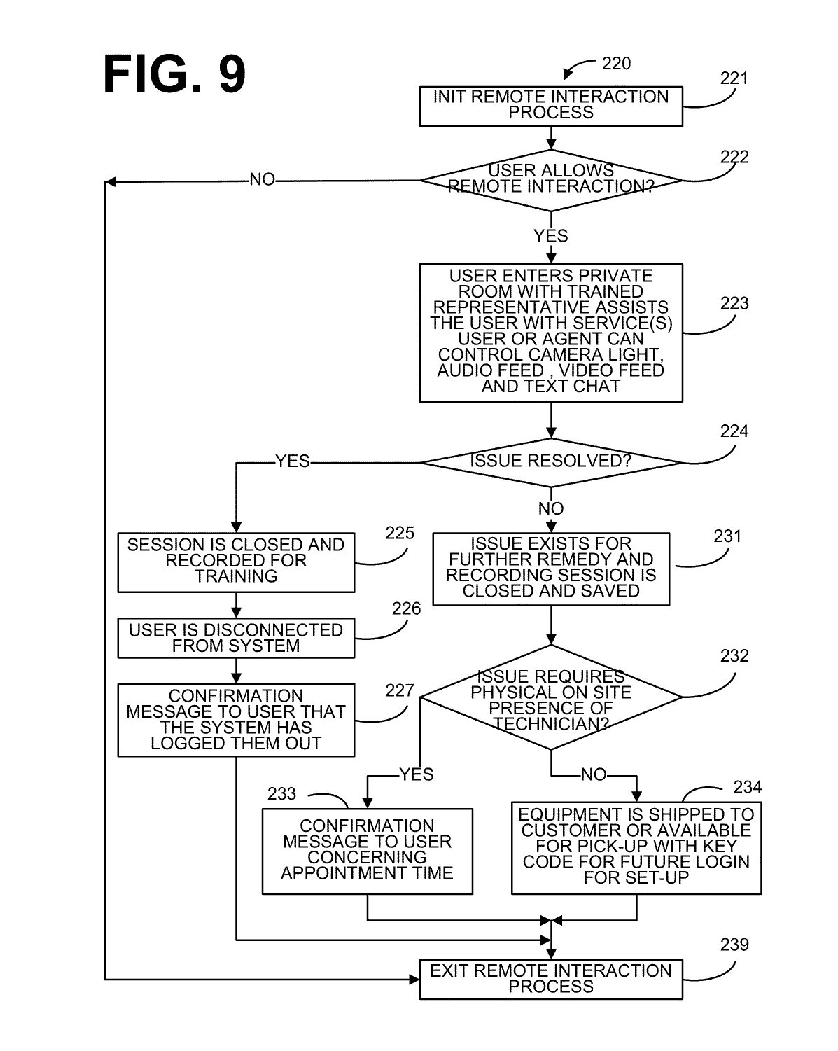

FIG. 9 is a flow chart illustrating an example of the operation of remote interaction process 220 that is utilized in the remote servicing system 100 of the present invention, as shown in FIGS. 2A, 3A & 4A. The remote interaction process 220 enables the interaction between the user and a remotely located service technician to resolve issues with the equipment to be serviced.

First at step 221, the remote interaction process 220 is initialized. This initialization includes the startup routines and processes embedded in the BIOS of the server 11. The initialization also includes the establishment of data values for particular data structures utilized in the remote interaction process 220.

At step 222, the remote interaction process 220 determines if the user allows remote interaction with a remotely located service technician to resolve issues with the equipment to be serviced. If the remote interaction process to 20 determines that the user does not allow remote interactions, and the remote interaction process to 20 then skips to step 239 to exit.

However, it is determined at step 222 that the user does allow remote interactions, then the user enters a private chat room with a trained representative to assist the user with the service or services at step 223. While in the remote private chat room, the user or the agent can control the camera, light, audio CD, video feed and text chat. At step 224, it is determined if the interaction with the trained representative was able to resolve the current issue. If it is determined at step 224 that the current issue was not resolved, then the remote interaction process to 20 then skips the step 231. However, if it is determined that the current issue was resolved, then the remote interaction process 220 closes the session in recording for future training. At step 226 the user is disconnected from the remote services system. A confirmation message is sent to the user notifying them that the system has logged them out at step 227. The remote interaction process 220 then skips the step 239 to exit.

At step 231, after it is determined at step 224 that the current issue has not been resolved, then the current issue exists for further remedy and the recording session is closed and saved for future review. At step 232, it is determined if the current issue requires a physical on-site presence of the technician. If it is determined at step 232 that the physical presence of a technician on-site is required, then the remote interaction process 220 sends a confirmation message to the user concerning the appointment time for the technician to provide on-site service. The remote interaction process 220 then skips the step 239 to exit. However, if it is determined at step 232 that the current issue does not require the physical on-site presence of a technician, and the equipment needed to correct the current issue issued to the customer or is made available for pickup with a key code for future login or set up of the equipment being sent.

The remote interaction process 220 then exits at step 239.

FIG. 10A is a flow chart illustrating an example of the operation of the policy process 240 of the present invention utilized by the server 11, as shown in FIGS. 2A & 3A. The policy process 240 enables a user to acquire a quote for remote support, perform administration changes/modifications to the current policy or perform a claim process on an existing policy.

First at step 241, the policy process 240 is initialized. This initialization includes the startup routines and processes embedded in the BIOS of the server 11. The initialization also includes the establishment of data values for particular data structures utilized in the policy process 240.

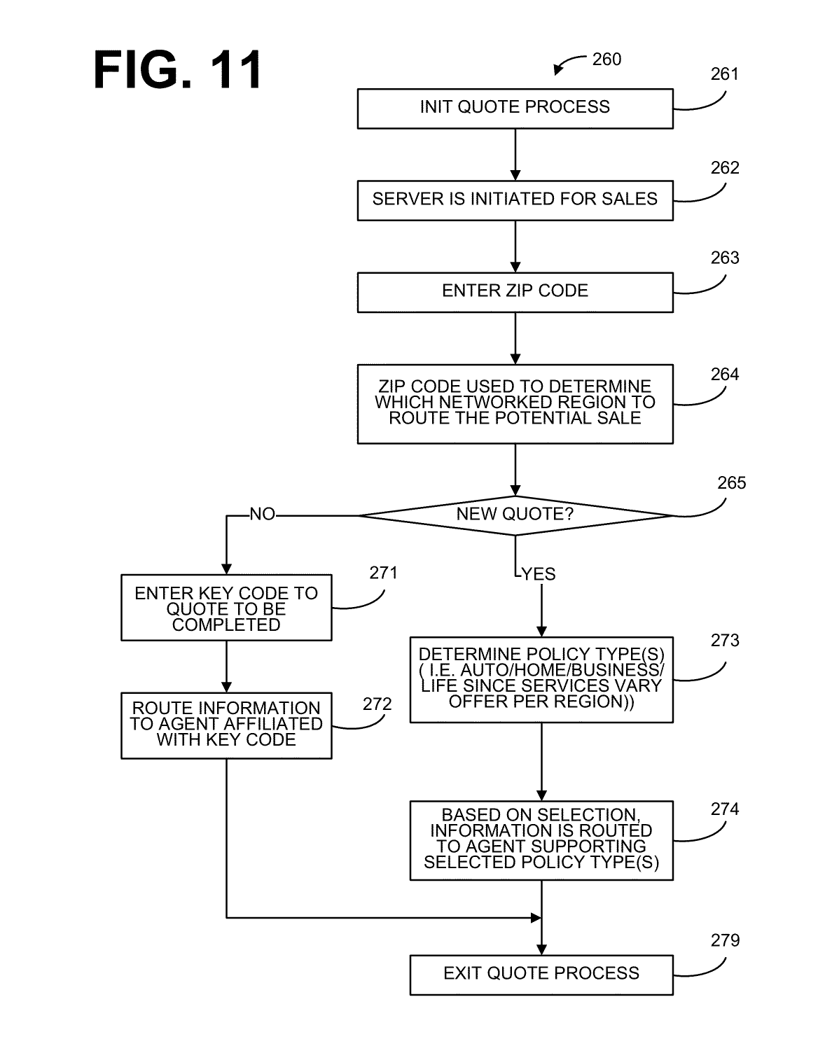

At step 242, the policy process 240 make sure user to initiate the application from an icon. In a preferred embodiment, the icon is displayed on the remote device 15 for the user to engage. In alternative embodiments there are numerous other ways to initiate the process including, but not limited to requesting a policy action. After receiving a request from the user to perform the policy process, it is then determined if the user input the login key at step 243. If it is determined at step 243 that the user did not input the login key, then the policy process 240 determines that the user wants to have a quote generated for a service policy. The policy process 240 then skips to step 248 to perform the quote process. The quote process is herein defined in further detailed with regard to FIG. 11. However, if it is determined at step 243 that the user did input the login key, then it is determined if the login key code was a valid login key at step 244.

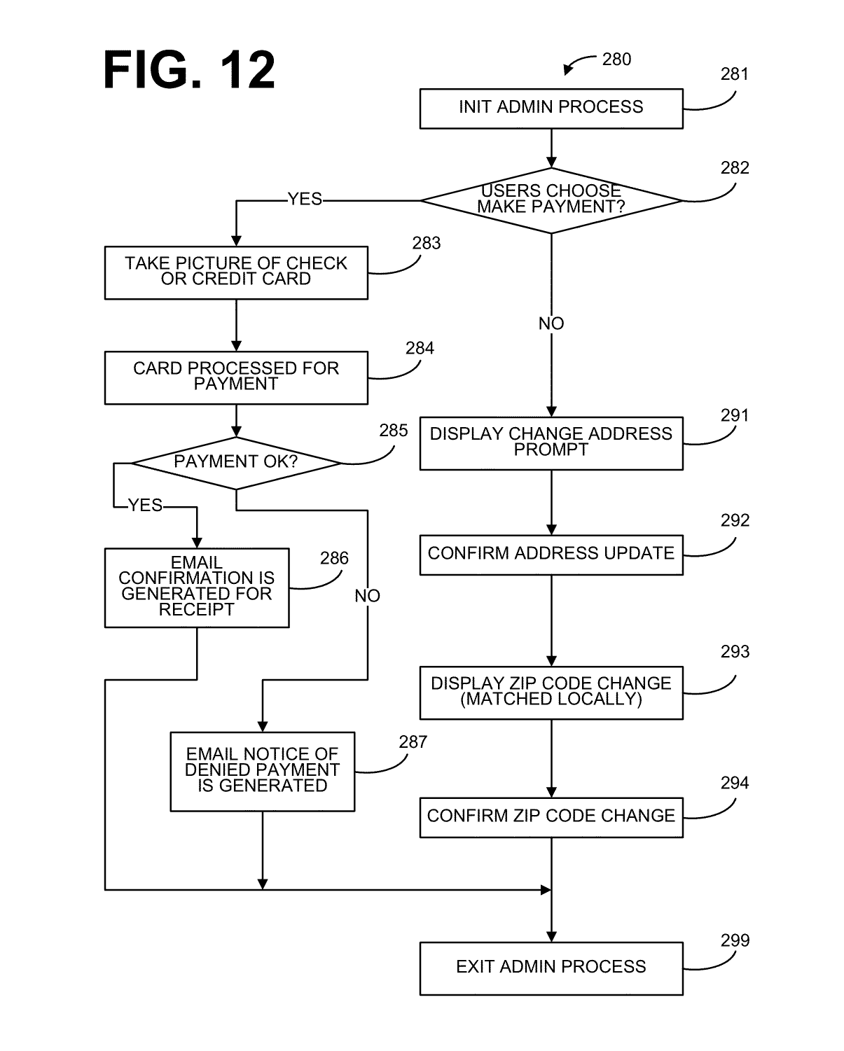

If it is determined in step 234 that the user did not input a login key code was a valid login key, then the policy process 240 returns to repeat step 243. However, if it is determined at step 244 that the login key code input was a valid login key, then the policy process 240 determines if the task performed is to be an administrative task, at step 245. If it is determined in step 245 that the task to be performed is not an administrative task, then the policy process 240 skips to step 247. However, if it is determined in step 245 that the task be performed is an administrative task, then the policy process 240 performs the admin process at the step 246. The admin process is herein defined in further detail with regard to FIG. 12. After performing the admin process, the policy process 240 skips to step 251.

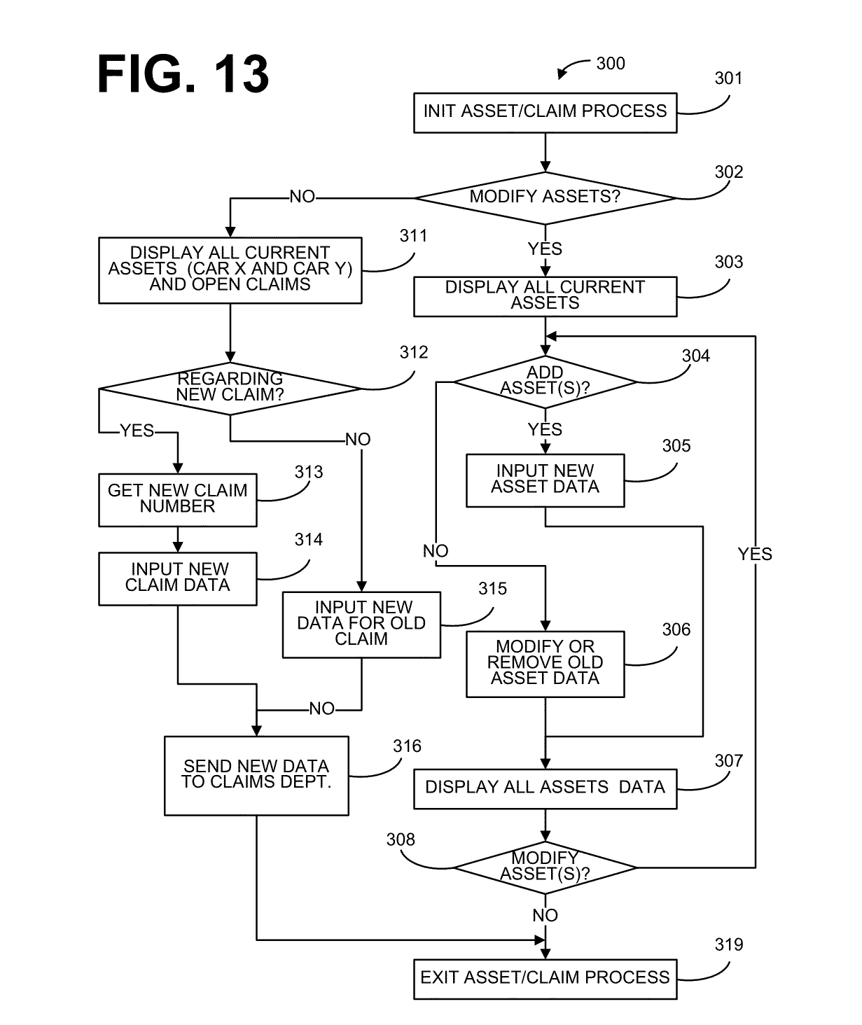

At step 247, the policy process 240 performs the asset/claim process. The asset/claim process is herein defined in further detail with regard to FIG. 13. After performing the asset/claim process, the policy process 240 skips to step 251.

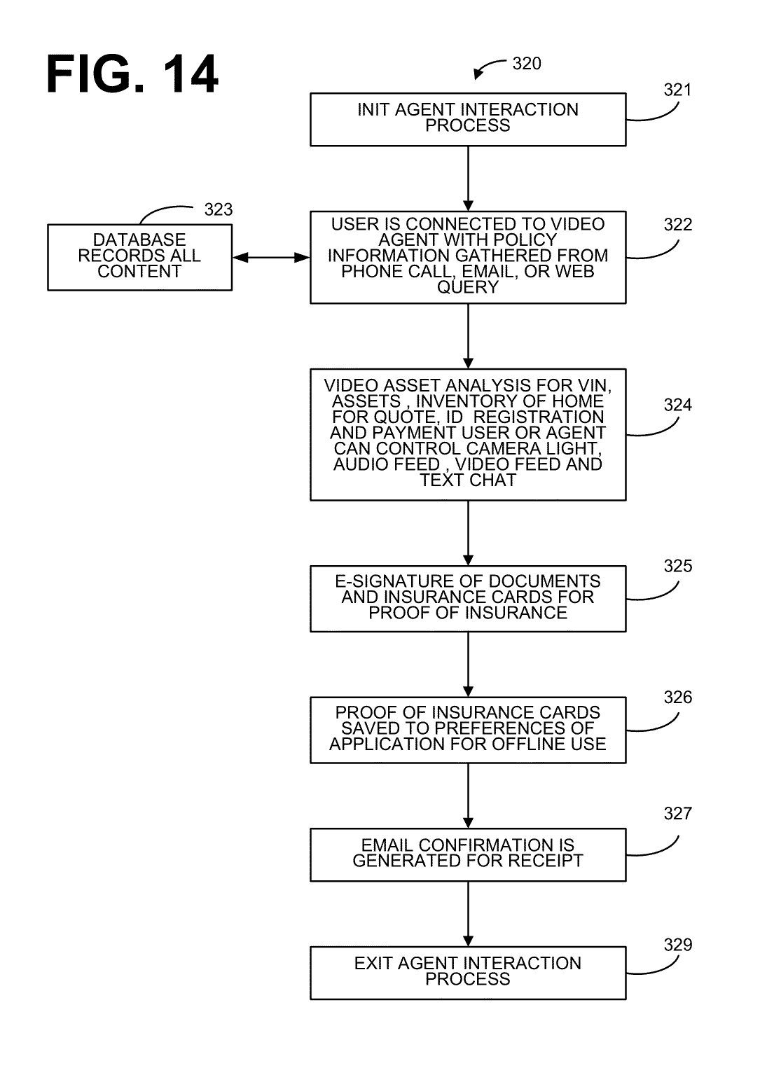

At step 251, the policy process 240 determines if agent interaction is required. If it is determined that agent interaction is not required, then the policy process 240 skips to step 253. However, if it is determined at step 251 that agent interaction is required, then the policy process 240 performs at the agent interaction process, at step 252. The agent interaction process is herein defined in further detail with regard to FIG. 14.

At step 253, the policy process 240 then uses the new information (i.e. information from the quote process, admin process, or asset/claim process) to updates the database 12 and counting ballots is account at step 254. At step 255, the policy process 240 determines if there are more policies to be processed. If it is determined at step 255 that there are more policy to be processed, then the policy process 240 returns to repeat steps 242-255. However, if it is determined that there are no more policies to be processed, then the policy process 240 exits at step 259.

FIG. 10B is a flow chart illustrating an example of the operation of the policy app 700 for the remote device 15 of the present invention, as shown in FIG. 2B. The policy app 700 enables a user to acquire a quote for remote support, perform administration changes/modifications to the current policy or perform a claim process on an existing policy.

First at step 701, the policy app 700 is initialized. This initialization includes the startup routines and processes embedded in the BIOS of the server 11. The initialization also includes the establishment of data values for particular data structures utilized in the policy app 700.

At step 702, the policy app 700 for the remote device 15 waits to receive an action request. Next, a welcome screen explaining the services provided is displayed in the user is prompted to initiate an application from the icon displayed a welcome screen at step 703. At step 704, the user enters a valid key code when initiating the application from an icon. The policy app 700 accesses the policy server 11 to display a list of the policy providers, at step 705.

At step 706, the user is prompted to choose a whether the current action is with regard to a claim or quote. After the user selects the type of action with regard to a claim or quote, the policy app 700 connects to an agent to explain the claim or policy quote, at step 711. Next, the user enters a private chat room with an agent at step 712. In the private chat room, the agent assists with services that either the user or agent can control. The services that the user or agent can control include, but are not limited to, camera light, audio feed, video feed, text chat and the like. This is how the user and agent are able to disclose the actual state of apparatus/device needing a policy claim or policy quote.

Last, it is determined if there is more interaction with this user, at step 713. If it is determined that there is more interaction with this user, then the policy app 700 returns to step 702 to wait for the user to initiate the action request. However, if there is no more interaction with the user, the policy app 700 then exits at step 239.

FIG. 11 is a flow chart illustrating an example of the operation of the quote process 260 that is utilized in the remote servicing system 100 of the present invention, as shown in FIGS. 2A, 3A & 10A. The quote process 260 enables a national call center to receive a contact from a user that wants to receive a new quote for a policy or complete a policy quote that was already initiated. Once the location of the user is determined, then the proper a regional office to handle the policy is determined.

First at step 261, the quote process 260 is initialized. This initialization includes the startup routines and processes embedded in the BIOS of the server 11. The initialization also includes the establishment of data values for particular data structures utilized in the quote process 260.

At step 262, the quote process 260 server 11 is initiated for sales. At step 263, the zip code of the user is input. At step 264, the ZIP code is used to determine which network region to route the potential sale.

At step 265, it is determined if the user wishes to generate a new quote for a policy. If it is determined at step 265 that a new quote is to be generated, then the quote process 260 then skips to step 273. However, if it is determined in step 265 that a new quote is not to be generated, then the quote process 260 requests the user to enter a key code to a quote that needs to be completed at step 271. At step 272, the information and the user are routed to a agent affiliated with the key code. The quote process 260 then skips to step 279.

At step 273, the quote process 260 determines a policy type that they user wishes to create. The policy types include, but are not limited to auto, home, business, life insurance services, and the like. Then, based upon the policy type selection, the information is routed to the agent supporting that policy type in the user's geographical region at step 274.

The quote process 260 then exits at step 279.

FIG. 12 is a flow chart illustrating an example of the operation of admin process 280 that is utilized in the remote servicing system 100 of the present invention, as shown in FIGS. 2A, 3A & 10A. The admin process 280 enables a user to make a payment, and change address type information.

First at step 281, the admin process 280 is initialized. This initialization includes the startup routines and processes embedded in the BIOS of the server 11. The initialization also includes the establishment of data values for particular data structures utilized in the admin process 280.

At step 282, the admin process 280 determines if the user wishes to make a payment or a change address type information. If it is determined in step 282 that the user wants to change address type information, then the admin process 280 then skips to step 291. However, is determined at step 282 that the user does not want to change address information, then it is determined that the user wants to make a payment. At step 283, they user is instructed to take a picture of a check or credit card and upload that information to the admin process to me. At step 284, the check or credit card is processed for payment.

Step 285, the admin process 280 determines if the payment was processed successfully. If it is determined that the payment was unsuccessfully processed, then the admin process 280 skips to step 287. However, if it is determined at step 285. Payment was processed successfully, then the admin process 280 e-mails a confirmation of the successful payment processing to the user. This e-mail confirmation is a receipt as evidenced to the successful payment processing. The admin process 280 then skips to step 299.

At step 287, the admin process 280 generate a notice of denied payment that is e-mailed to the user. This e-mail is to put the user on notice that the payment was not successful and therefore at the policy may be canceled if payment is not received in a predetermined period of time. The admin process 280 then skips to step 299.

At step 291, then admin process 280 displays a change address prompt. This enables the user to update their address information. After entering the change of address information, the admin process 280 confirmed the address update at step 292. At step 293, the admin process 280 displays the ZIP code change prompt. This enables a user to update their ZIP code information. After entering the change of ZIP code information, that admin process 280 confirms the ZIP code update at step 294.

The admin process 280 then exits at step 299.

FIG. 13 is a flow chart illustrating an example of the operation of asset/claim process 300 that is utilized in the remote servicing system 100 of the present invention, as shown in FIGS. 2A, 3A & 10A. The asset/claim process 300 enables a user to document all their current assets protected by a policy. These records of assets may be added to, modified and removed. In one embodiment, pictures of each asset are input into the asset/claim process 300 in order to verify the assets, their serial numbers and the like.

First at step 301, the asset/claim process 300 is initialized. This initialization includes the startup routines and processes embedded in the BIOS of the server 11. The initialization also includes the establishment of data values for particular data structures utilized in the asset/claim process 300.

At step 302, the asset/claim process 300 determines if the user wants to modify the current records of the user's assets. If it is determined in step 302 that the user does not want to modify the current records of the user's assets, then the asset/claim process 300 then skips to step 311. However, is determined at step 302 that the user does want to modify the current records of the user's assets, then the asset/claim process 300 displays all of the current asset records for the user at step 303. At step 304, it is determined if the user wishes to add one or more asset records to the asset/claim process 300. If it is decided that the user does not wish to add any asset records, then the asset/claim process 300 skips to step 306. However, if it is determined that the user does wish to add at least one asset record to the asset/claim process 300, then the user is encouraged input the new asset data at step 305. The asset/claim process 300 then skips to step 307.

At step 306, the user is prompted to modify or remove old asset data records. These asset records are kept in order to have itemized list of those assets covered by a policy.

At step 307, the asset/claim process 300 displays all of the asset data records for the user. At step 308, the asset/claim process 300 determines if the user wishes to modify more records regarding the user's assets. If it is determined in step 302 that the user does want to modify the current records of the user's assets, then the asset/claim process 300 then returns to repeat steps 304-308. However, is determined at step 308 that the user does not want to modify the more records of the user's assets, then the asset/claim process 300 skips to step 319.

At step 311, the asset/claim process 300 displays all the current assets for the user and any open claims. At step 312, it is determined whether or not the user is contacting the remote servicing system 100 regarding a new claim. If it is determined at step 312 that the user is not contacting the remote servicing system 100 regarding a new claim, then the asset/claim process 300 skips to step 315. However, if it is determined at step 312 that the user is contacting the remote servicing system 100 regarding a new claim, then the asset/claim process 300 gets the new claim number at step 313. At step 314, the user inputs the new claim data, and then the asset/claim process 300 skips to step 316.

At step 315, the user inputs new data for an old claim. This new data for an old claim to be any relevant information including but not limited to estimates for repair, estimates for replacing and the like.

At step 316, the new data from the new policy or the old policy are sent to the claims department.

At step 316, the asset/claim process 300 then exits.

FIG. 14 is a flow chart illustrating an example of the operation of agent interaction process 320 that is utilized in the remote servicing system 100 of the present invention, as shown in FIGS. 2A, 3A & 10A. the agent interaction process 320 enables a user to connect to an agent to capture video, audio, text and the like information.

First at step 321, the agent interaction process 320 is initialized. This initialization includes the startup routines and processes embedded in the BIOS of the server 11. The initialization also includes the establishment of data values for particular data structures utilized in the agent interaction process 320.

At step 322, the agent interaction process 320 connects a user with a video agent with policy information gathered from a phone call, email or web query. The information collected and displayed is obtained from the database 12 at step 323. Will be agent interaction process enables video asset analysis for VIN, assets, inventory of home for policy quote, ID registration and payment. It is understood that either the user or agent can control the video, camera or any other data capturing device.

At step 325 and electronic signature of documents and insurance cards for proof of insurance are provided. At step 326, the proofs of insurance cards are saved to preferences of the application for off-line use. The off-line use, may be, but is not limited to access by law enforcement to determine whether or not there is a insurance policy on a vehicle to be in compliance with state law.

A. e-mail confirmation is generated and sent to the user as a receipt at step 327. The agent interaction process 320 then exits at step 329.

FIG. 15 is a flow chart illustrating an example of the operation of the intelligent routing process 340 that is utilized in the remote servicing system 100 of the present invention, as shown in FIGS. 2A, 3A & 8A. The intelligent routing process is one that determines if a user has contacted customer service agent previously for processing a claim, verifies that that agent is available and connect that agent to the customer if that customers desires.

First at step 341, the intelligent routing process 340 is initialized. This initialization includes the startup routines and processes embedded in the BIOS of the server 11. The initialization also includes the establishment of data values for particular data structures utilized in the intelligent routing process 340.

At step 232, the intelligent routing process 340 enables a user to contact customer service. At step 343, the user enters the account information such as a phone number for tracking policies and claims. At step 344, this server 11 references a valid account information utilizing the account info captured at step 343. At step 345, the intelligent routing process 340 checks the account information of the user against recent issues and agents handling those issues.

At step 351, it is determined is the user has had recent issues. If it is determined at step 351 that the user has not had recent issues, then the intelligent routing process 340 then skip to step 355. However, if it is determined at step 351, that the user has had recent issues, then the intelligent routing process 340 determines if the agent who previously assisted the user is available at step 352. If it is determined at step 352 that the agent who previously assisted the user is available, then the intelligent routing process 340 then skip to step 355. However, if it is determined at step 352 that the agent who previously assisted the user is available, then the intelligent routing process 340 determines if the user wants to contact that agent to discuss the recent issue. If it is determined at step 353 that the user does not wish to contact the agent who previously assisted user, then the intelligent routing process 340 then skip to step 355. However, if it is determined at step 353 that the user does wish to contact the agent who previously assisted user, then the call is routed to that agent at step 354. The intelligent routing process 340 then skips to step 359.

At step 355, the call is routed to any other unavailable agent.

The intelligent routing process 340 then exits at step 359.

Any process descriptions or blocks in flow charts should be understood as representing modules, segments, or portions of code which include one or more executable instructions for implementing specific logical functions or steps in the process, and alternate implementations are included within the scope of the preferred embodiment of the present invention in which functions may be executed out of order from that shown or discussed, including substantially concurrently or in reverse order, depending on the functionality involved, as would be understood by those reasonably skilled in the art of the present invention.

It should be emphasized that the above-described embodiments of the present invention, particularly, any “preferred” embodiments, are merely possible examples of implementations, merely set forth for a clear understanding of the principles of the invention. Many variations and modifications may be made to the above-described embodiment(s) of the invention without departing substantially from the spirit and principles of the invention. All such modifications and variations are intended to be included herein within the scope of this disclosure and the present invention and protected by the following claims.

1. A method for delivering remote servicing embodied in a computer program product for execution on an instruction processing system, comprising a tangible storage medium readable by the instruction processing system and storing instructions for execution by the instruction processing system for performing the method comprising:
receiving a phone call from a customer;
receiving a digital image of a device being serviced by a service representative;
displaying the digital image of the device being serviced on a monitor to the service representative; and
determining if a service tech needs to make a service visit.

2. The method of claim 1, further comprising:
using a imaging capturing device to create the digital image of the device being serviced.

3. The method of claim 2, wherein the imaging capturing device further comprises:
remote controlling the imaging capturing device by the service representative.

4. The method of claim 3, wherein the remote controlling further comprises:
remote controlling a light to aid in low light operation of imaging capturing device.

5. The method of claim 2, wherein the imaging capturing device is a digital camera.

6. The method of claim 2, wherein the imaging capturing device further comprises:
a video camera.

7. The method of claim 1, further comprising:
using a central database of zip codes to route the phone call to a regional call center.

8. The method of claim 1, wherein the phone call further comprises:
receiving a web request.

9. The method of claim 1, further comprising:
directing the customers to a payment screen if service has been disabled for non-payment.

10. The method of claim 1, further comprising:
using a unique identifier to initiate the type of service to be provided.

11. A system for delivering remote servicing on a computer system, comprising:
a tangible storage medium readable by the computer system and storing instructions for execution by the computer system;
a means receiving a phone call from a customer;
a means receiving a digital image of a device being serviced by a service representative;
a means displaying the digital image of the device being serviced on a monitor to the service representative; and
a means determining if a service tech needs to make a service visit.

12. The system of claim 11, further comprising:
a imaging capturing device to create the digital image of the device being serviced.

13. The system of claim 2, wherein the imaging capturing device further comprises:
remote control means on the imaging capturing device to enable the service representative to remote control the imaging capturing device.

14. The system of claim 3, wherein the remote control means further comprises:
a remote control for a light on the imaging capturing device to enable the service representative to aid in low light operation of imaging capturing device.

15. The system of claim 12, wherein the imaging capturing device further comprises:
a digital camera.

16. The system of claim 12, wherein the imaging capturing device further comprises:
a video camera.

17. The system of claim 11, further comprising:
a central database of zip codes to route a mobile application request to a regional call center.

18. The system of claim 11, wherein the phone call further comprises:
a web request.

19. The system of claim 11, further comprising:
a payment screen that the customers is directed to if service has been disabled for non-payment.

20. The system of claim 11, further comprising:
means for using a unique identifier to initiate the type of service to be provided.
